(19) United States
(12) Patent Application Publication
(10) Pub. No.: US 2014/0095395 A1
(43) Pub. Date: Apr. 3, 2014

(54) APPARATUS, METHOD AND SYSTEM FOR VARIABLE COMMISSION STRUCTURE AFFILIATE SALES NEGOTIATION AND TRACKING

(71) Applicant: Yekra, LLC, Las Vegas, NV (US)

(72) Inventors: Miles Romney, Salt Lake City, UT (US); Lee Waterworth, Northridge, CA (US)

(73) Assignee: Yekra, LLC, Las Vegas, NV (US)

(21) Appl. No.: 14/030,932

(22) Filed: Sep. 18, 2013

Related U.S. Application Data
(60) Provisional application No. 61/702,632, filed on Sep. 18, 2012.

(51) Int. Cl. G06Q 50/18; G06Q 30/02

(52) U.S. Cl. CPC G06Q 50/188; G06Q 30/0214
USPC 705/80

(57) ABSTRACT

An apparatus, system, and method are disclosed for variable commission structure affiliate sales negotiation and tracking. An apparatus is disclosed that includes a receiving module that receives a plurality of sales terms upon which a vendor's product may be made available for resale, a connection module that connects the vendor to one or more resellers based on the sales terms, and a negotiation module that negotiates between the vendor and the resellers, the negotiation module rejecting modified offers from resellers that have not met a performance threshold.

### CROSS-REFERENCES TO RELATED APPLICATIONS

This application claims the benefit of, U.S. Provisional Patent Application No. 61/702,632 entitled “APPARATUS, METHOD AND SYSTEM FOR VARIABLE COMMISSION STRUCTURE AFFILIATE SALES NEGOTIATION AND TRACKING” and filed on Sep. 18, 2012 for Miles Romney, which is incorporated herein by reference.

### FIELD

The present invention relates to affiliate sales, and more particularly to matching many affiliates salesmen to many product vendors.

### BACKGROUND

Traditionally, Affiliate sales management is a segmented process involving relationships between many Resellers and a single Vendor. In situations where multiple Vendors may be required, the process would necessarily be abstracted to its barest requirements, offering a single (or fixed range) of commission tiers requiring manual oversight and Affiliate assignment. No such system has been offered to date, that meets the needs of multiple Vendors (of varying prominence and quality) and multiple Affiliates (of varying prominence and proficiency).

Typically, content owners contract with individual resellers. This provides limited exposure for content owners. Furthermore, content owners, or vendors typically submit offers for resellers and the resellers may either accept or reject the offers. Due to the number of resellers, negotiating with individual resellers can be very time consuming.

A few online facilitators for affiliate sales include Commission Junction, and ShareASale, however, increased exposure can often lead to overwhelming numbers of offers and negotiation efforts.

### SUMMARY

An apparatus for tracking multiple variable commissions and resale negotiations is disclosed. A system and method also perform the functions of the apparatus. In one embodiment, the apparatus may include a receiving module that receives a plurality of sales terms upon which a vendor's product may be made available for resale. In another embodiment, the apparatus may include a connection module that connects the vendor to one or more resellers based on the sales terms. In a further embodiment, the apparatus may include a negotiation module that negotiates between the vendor and the resellers, the negotiation module rejecting modified offers from resellers that have not met a performance threshold. In one embodiment, at least a portion of the receiving module, the connection module, and the negotiation module comprise one or more of hardware and executable code, the executable code stored on one or more computer readable storage media.

In another embodiment, the sales terms include one or more of a base sales rate and an availability window. In a further embodiment, the apparatus also includes a monitor module that monitors individual reseller performance and adds individual reseller performance metrics to a database. In one embodiment, the performance threshold of the reseller comprises one or more of the size of an email list, a number of followers, a number of website visits, total sales figures, and previous sales with the vendor.

In one embodiment, the connection module is further configured to search, in response to a reseller, for vendors based on one or more of a content rating, an offered sales commission rate, and a content genre. In another embodiment, the connection module performs one or more of searching for a vendor in response to a reseller, importing a contact list in response to a vendor, and importing a contact list in response to a reseller. In a further embodiment, the apparatus further includes a deployment module that provides deployment tools, the deployment tools comprising one or more of a universal resource locator, a link, a widget, a blog, and a social network.

A method for tracking multiple variable commissions and resale negotiations is disclosed. In one embodiment, the method includes receiving a plurality of sales terms upon which a vendor's product may be made available for resale. In another embodiment, the method includes connecting the vendor to one or more resellers based on the sales terms. In a further embodiment, the method includes negotiating between the vendor and the resellers, wherein modified offers from resellers that have not met a performance threshold are rejected.

In one embodiment, the sales terms include one or more of a base sales rate and an availability window. In another embodiment, the method includes accepting offers from multiple resellers, wherein one or more of the accepted offers have different sales terms that others of the accepted offers. In a further embodiment, the method includes tracking sales for respective resellers, and adding tracked sales information into a database.

In one embodiment, the performance threshold includes one or more of an email list size, a number of followers, a number of website visits, a total sales amount, and a sales amount with the vendor. In another embodiment, the connecting includes connecting resellers to vendors based on one or more of a content rating, a sales commission base rate, and a content genre. In a further embodiment, the connecting includes receiving a contact list of resellers from a vendor, and indicating the sales terms to the resellers in the contact list.

In one embodiment, the method further includes deploying one or more vendor's products using one or more of a universal resource locator, a link, a widget, a blog, and a social network.

A computer program product for tracking multiple variable commissions and resale negotiations is disclosed. In one embodiment, the computer program product includes a computer readable storage medium having program code embodied therein, the program code readable/executable by a processor. In another embodiment, the program code includes a receiving module that receives a plurality of sales terms upon which a vendor's product may be made available for resale. In a further embodiment, the program code includes a connection module that connects the vendor to one or more resellers based on the sales terms. In one embodiment, the program code includes a negotiation module that negotiates between the vendor and the resellers. In another embodiment, the negotiation module may reject modified offers from resellers that have not met a performance threshold.

In one embodiment, the program code further includes a monitor module that monitors individual reseller performance and adds individual reseller performance metrics to a database. In another embodiment, the negotiation module negotiates between a vendor and a reseller based on properties of the reseller. In a further embodiment, the properties of the reseller comprise one or more of the size of an email list, a number of followers, and a number of website visits, total sales figures, and previous sales with the vendor.

In one embodiment, the program code further includes a user interface module that interfaces with one or more of a vendor and a reseller. In another embodiment, the connection module is further configured to connect resellers to vendors based on one or more of a content rating, a base commission rate, and a content genre.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an apparatus for variable commission structure affiliate sales negotiation and tracking in accordance with the present invention;

FIG. 2 is a perspective view illustrating one embodiment of an apparatus for variable commission structure affiliate sales negotiation and tracking in accordance with the present invention;

FIG. 3 is a block diagram illustrating one embodiment of a system for variable commission structure affiliate sales negotiation and tracking in accordance with the present invention;

FIG. 4 is a schematic block diagram illustrating one embodiment of a system for variable commission structure affiliate sales negotiation and tracking in accordance with the present invention;

FIG. 5 is a flow chart diagram illustrating one embodiment of a method for variable commission structure affiliate sales negotiation and tracking in accordance with the present invention;

FIG. 6 is a flow chart diagram illustrating one embodiment of a method for variable commission structure affiliate sales negotiation and tracking in accordance with the present invention;

FIG. 7 depicts an embodiment of an interface for a broad overview of available features and datasets available to a vendor;

FIG. 8 is an embodiment of an interface for a broad overview of available features and datasets available to a reseller;

FIG. 9 is an illustration of a user interface available to a vendor;

FIG. 10 is an illustration of one possible user interface for the available functions surrounding negotiation;

FIG. 11 is an illustration of some possible functional options for importing contacts;

FIG. 12 is an illustration of one possible interface for selecting contacts to import;

FIG. 13 is an illustration of a user interface for adding a single contact;

FIG. 14 is an illustration of one possible interface for sending an invitation and making an offer;

FIG. 15 is an illustration of one possible interface for the process of selecting multiple contacts;

FIG. 16 is an illustration of one possible interface for sending invitations;

FIG. 17 is an illustration of one possible interface for a vendor to activate a service;

FIG. 18 is an illustration of one possible interface for modifying which products have been selected by a vendor;

FIG. 19 is an illustration of one possible interface for selecting multiple products to activate;

FIG. 20 is an illustration of one possible interface for providing sales statistics and reports;

FIG. 21 depicts an embodiment of an interface for configuring global configuration settings;

FIG. 22 is an illustration of one possible interface for the available functions surrounding negotiation and managing re-sale Agreements.

FIG. 23 is an illustration of one possible interface for an overview of available features;

FIG. 24 is an illustration of one possible interface for manage existing re-sale agreements;

FIG. 25 is an illustration of one possible interface for managing existing product Deployments;

FIG. 26 is an illustration of one possible interface retrieve “embed codes” for an existing product deployment;

FIG. 27 is an illustration of one possible interface for configuring a new product deployment;

FIG. 28 depicts an embodiment of an interface for allowing an Affiliate to search Vendor-configured products, in order to identify products the Affiliate may wish to re-sell;

FIG. 29 depicts an embodiment of an interface for representing products that are available;

FIG. 30 depicts an embodiment of an interface for representing product search results;

FIG. 31 depicts an embodiment of an interface for representing product search results;

FIG. 32 is an illustration of one possible interface for representing sales figures;

FIG. 33 is an illustration of one possible interface for managing his account and user settings.

FIG. 34 is an illustration of one possible interface for allowing new resellers to register as affiliates.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

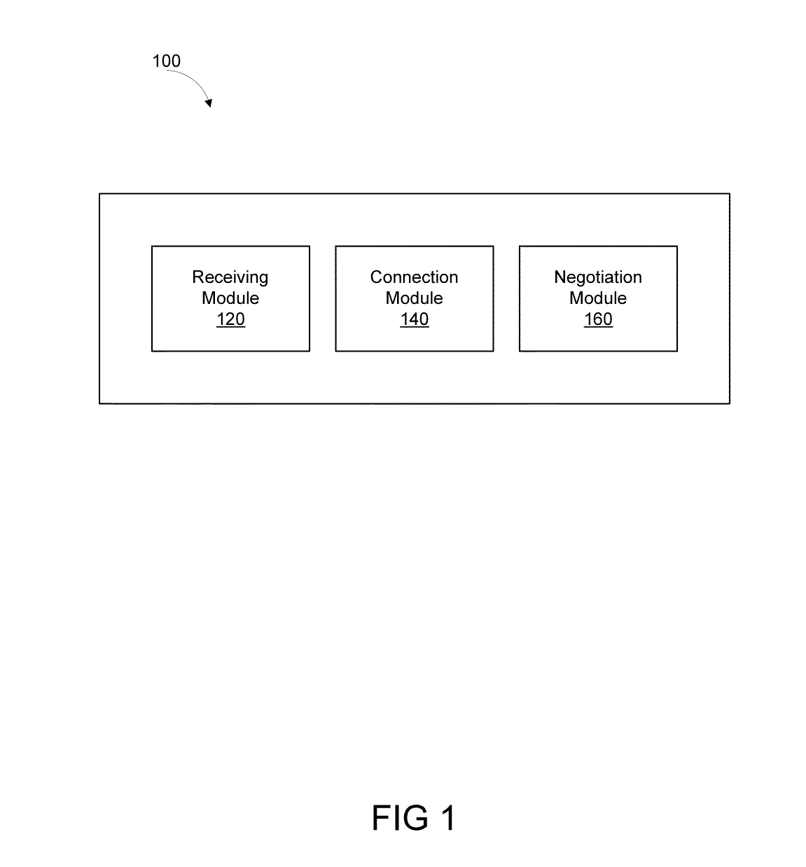

FIG. 1 is a perspective view illustrating one embodiment of an apparatus for variable commission structure affiliate sales negotiation and tracking in accordance with the present invention. In one embodiment, the apparatus may include a receiving module 120, a connection module 140, and a negotiation module 160.

In one embodiment, a receiving module 120 may be configured to receive a plurality of sales terms upon which a vendor's product may be made available for resale. In one embodiment, a vendor may be a party that owns sales rights to a product that may be sold. In one embodiment, an affiliate may be any party who may resell the vendor's product. In a few examples, a vendor's product may be sold online, via email, via a blog, via a website, via a third-party feed service, via a social network, or the like.

As described herein, a vendor may include an individual or corporate entity that may provide media content for resale. In some examples, resale content may include movies, commercials, videos, audio, sound recordings, images, portraits, photographs, other media content, or the like.

In one embodiment, a connection module 140 connect a vendor to one or more resellers. In another embodiment, the connection between the vendor and a reseller may be based on the sales terms provided by the vendor.

A reseller, as described here may include a distributor, reseller, affiliate, sales organization, or other, or the like. In one embodiment, a reseller may promote sales of a product or service using a blog, using a social media service, a website, a radio advertisement, a commercial, other advertisements, or other, or the like.

In one embodiment, a negotiation module 160 may negotiate between a vendor and a reseller. In one embodiment, the negotiation module 160 may reject offers from resellers that have not met a performance threshold. For example, a performance threshold may include one or more of a size of an email list, a number of followers, a number of website visits, total sales figures, and previous sales with the vendor. In one example, an email size list may include 1000's of email addresses or millions of email addresses, or more, and a negotiation module 160 may limit negotiation by a reseller with less than a threshold number of emails in an email list. In another example, a number of followers may be hundreds, thousands, or more, and a negotiation module 160 may deny negotiations by a reseller with fewer than 10,000 followers. Of course other values may be used, and this disclosure is not limited in this regard. In another example, a number of website visits may be thousands, millions, or more, and a negotiation module 160 may ignore negotiations by a reseller with fewer than one million website visits over a period of time. For example, a performance threshold may be one million website visits over the past month. Of course, other numbers and time periods may be used and this disclosure is not limited in this regard.

In another embodiment, a connection module may be configured to search for a vendor in response to a request from a reseller. In another embodiment, a connection module 120 may be configured to import a contact list in response to a vendor. In another embodiment, a connection module 120 may be configured to import a contact list in response to a reseller. A contact list may include any of the different formats of contact described in this document, or others, or the like. In one embodiment, the connection module 120 may be configured to indicate sales terms to resellers in the list of contacts.

In one embodiment, a negotiation module 160 may negotiate different rates or availability windows based on performance criteria for a reseller. In one embodiment, a performance threshold may include total sales via the apparatus 100. For example, a performance threshold may include having one million dollars in sales via the apparatus. Therefore, in one example, the negotiation module 160 may deny negotiation by a reseller with fewer than one million dollars in sales via the apparatus 100.

In another embodiment, a performance threshold may include sales with a specific vendor. For example, a performance threshold may include having $20,000 in sales with the vendor via the apparatus 100. Therefore, in one example, the negotiation module 160 may deny negotiation by a reseller with fewer than $20,000 in sales with the specific vendor using the apparatus 100.

Terms of a sales contract may include, but is not limited to, payment schedule, payment amounts, product availability limitations, commission rates, commission base rates, commission bonus rates, payment terms, prices, shipments of products, risk management, risk allocation, modification provisions, negotiable terms, inspection rights, revocation rights, return policies, warranties, assignability clauses, damage limitations, limited liability, waiver terms, attorney fee provisions, conflict resolution, choice of law terms, or other, or the like.

In another embodiment, the negotiation module may prefer resellers with specific capabilities, properties, or criteria. For example, a negotiation module 160 may prefer negotiation by resellers with larger email lists. In another example, a negotiation module 160 may prefer negotiation by a reseller with more social network followers. Of course, other metrics may be used, including, but not limited to, reseller names, reseller ratings, reseller rankings, reseller reputation, reseller historical performance, reseller email lists, reseller sales metrics, or other, or the like. In another embodiment, a negotiation module 160 may negotiation different sales rates with resellers having different performance criteria, as described.

In one example, a content owner, may offer a 5% commission rate. A reseller may prefer a 10% commission rate. The negotiation module 160 may allow the reseller to offer the 10% commission rate if the reseller meets certain performance criteria as described. The negotiation module 160 may negotiation, in response to input from vendors and resellers until an agreed upon commission rate, such as 7%, has been met.

In another embodiment, a negotiation module 160 may notify a vendor in response to receiving an offer form a reseller with certain criteria. For example, a negotiation module 160 may notify a vendor in response to offers received from resellers that are 10% sales rates or higher. Therefore, a negotiation module 160 may ignore offers that are below a requested sales rate. Therefore, in one embodiment, a negotiation module 160 may filter offers from many resellers. This may help facilitate a vendor selecting preferred offers without having to analyze multiple offers below a certain standard.

In one embodiment, sales terms may include an availability window. An availability window may include, but is not limited to, a theatrical release, a transactional release, an online video on demand release, a general release, or the like. In one example, a theatrical release window may be from an initial release date and last for 3 weeks. In another example, a transactional release window may be from an end of a theatrical release window and last for two weeks. In another example, an online video on demand release window may be from an end of a transactional release window and last for many months. In another example, a general release window may be from an end of an online video on demand release window and last for many years, or longer. In another example, a general release window may not have an end date.

In one embodiment, a theatrical release window may define a time period in which a media content may only be disseminated in theaters. In another embodiment, a transactional release window may define a time period in which a media content may be disseminated via a pay-per-view system, or other transaction, or the like. In another embodiment, an online video on demand release window may define a time period in which a content may be distributed via an online media stream, an Internet server, or digitally in another way, or the like. In another embodiment, a general release window may define a time period in which a content may be distributed via other distribution means, such as, but not limited to, sales on a physical media, such as a DVD, transmitted via a television signal, or the like.

In one embodiment, a sales term may include a distribution window. As previously described, a negotiation module 160 may limit access to different sales windows, based on performance criteria of a reseller.

In one embodiment, a negotiation module 160 may restrict access to certain availability windows based on performance threshold. For example, a negotiation module 160 may allow negotiation for a theatrical release window if a reseller has over $1 million in sales via the apparatus.

In one embodiment, a negotiation module 160 may grant exclusive rights to one reseller for a theatrical release windows. In another embodiment, a negotiation module 160 may grant distribution rights to multiple resellers to another release window, such as, but not limited to, a transactional release window.

In one embodiment, a connection module may find resellers/affiliates indicated by a vendor. A connection module may receive a contact list from a vendor, and then invite the potential resellers to use the apparatus. In another embodiment, a connection module 140 request that another user search and discover other potential resellers. A contact list may include data in any format as one skilled in the art may recognize. For example, contact information may be included in a text file, a spreadsheet, a word processor, a digital file, or other, or the like.

In one embodiment, the connection module 140 provide varying levels of access to vendors by affiliates, or access to affiliates by vendors. For example, a connection module 140 may hide resellers or affiliates from content owners or vendors. In another example, a connection module 140 may hide vendors from affiliates, or the like. In another embodiment, a connection module 140 may allow access to users of the apparatus 100 based on groups, associations, or other types of links between vendors and affiliates.

In another embodiment, the connection module is configured to search, in response to a reseller, for vendors. In another embodiment, the search may be based on one or more of a content rating, an offered sales commission rate, and a content genre. For example, search terms may include one or more of the following: Product type (e.g. “streaming video”, “DVD”, “eBook”, “book”); Online vs. offline fulfilment (digital vs. physical goods); Thematic category (e.g. “Romance”, “Science Fiction”); Base Rate (e.g. “greater than 5%”); Sales History Threshold (e.g. “less than $10,000”); Popularity Tier (e.g. “over 100,000 sales”), Language (e.g. “English”), or other, or the like.

When a suitable product is identified by an Affiliate, the Affiliate has the option of choosing to engage a default re-sale agreement at the Base Rate, or (if the Affiliate's Sales History meets or exceeds the product's Sales History Threshold) enter into negotiation for a higher commission rate.

In another embodiment, an offer by a vendor may include a personal message or verbose explanation with the offer. Furthermore, a reseller may include a personal message or a verbose explanation with a counter offer. In response to an agreed upon set of sales terms, a negotiation module 160 may accept an agreement between a vendor and a reseller. In response to an accepted agreement, a negotiation module 160 may immediately provide resources to facilitate selling of the vendor's products. In one example, a negotiation module may provide a widget for a web page, a web link, a universal resource locator, or the like.

In one example, a web link, may contain a unique code which identifies the corresponding product(s), vendor(s), affiliate and agreement. The link may be posted online or offline through any means, including e-mail, text message, instant message, website or blog posting, or third-party feed-service posting (e.g. Facebook or Twitter). Following the link (e.g. clicking on the link) would lead an end-user to an area of the apparatus designed to walk the user through the purchase process (including order, payment, and any other necessary step).

In the case of a widget, in one embodiment, an embeddable applet may be created which provides user interface and functionality for the purchase (including order, payment, and any other necessary step) within a third-party website, blog, or social media page. The widget may include a unique code which identifies the Deployment, which in-turn identifies the corresponding product(s), vendor(s), affiliate and/or agreement.

In one embodiment, every end-user purchase transaction triggers the creation of a storage record in the database. This record may tracks all relevant elements of the transaction, including product, vendor, affiliate, deployment and agreement. At regular intervals, these records are polled and aggregated, and used to determine commission payments.

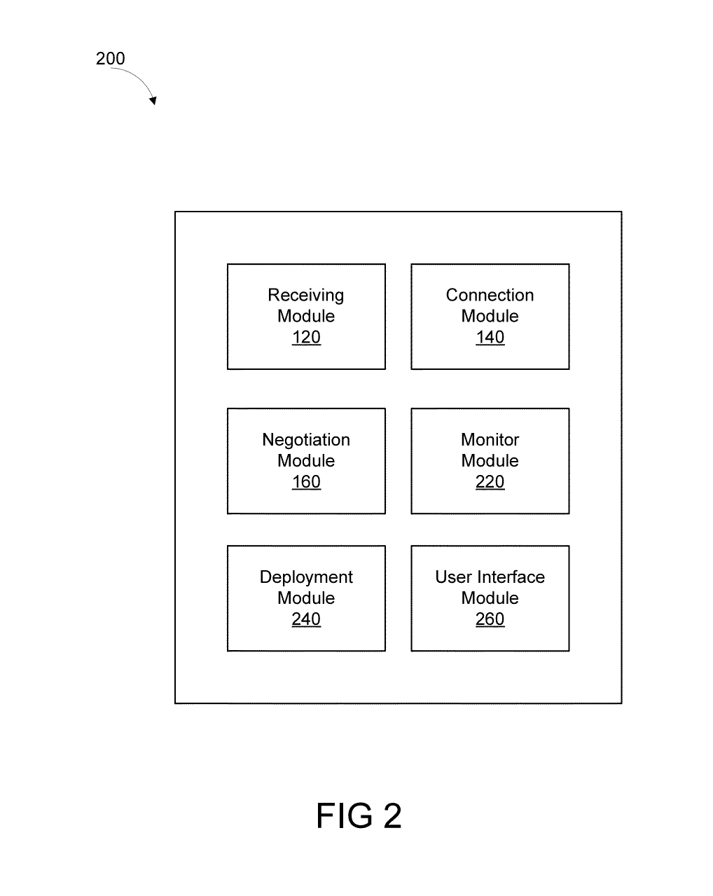

FIG. 2 is a perspective view illustrating one embodiment 200 of an apparatus for variable commission structure affiliate sales negotiation and tracking in accordance with the present invention. In one embodiment, the apparatus 200 may include a receiving module 120, a connection module 140, a negotiation module 160, a monitor module 220, a deployment module 240, and a user interface module 260. The receiving module 120, the connection module 140 and the negotiation module 160 may or may not be substantially similar to similar modules depicted in FIG. 1.

In one embodiment, the monitor module 220 monitors individual reseller performance and adds individual reseller performance metrics to a database. In another embodiment, the monitor module may track sales for a reseller. The tracking may be based on any of the aforementioned sales resources. For example, based on a URL link, the web site, a widget, an embedded code, or other, or the like.

In one embodiment, the database may include one or more of a remote database, a local database, a structured query language database, a flat file database, an online database, or other database, or the like.

In one embodiment, the deployment module may provide deployment tools for an affiliate reseller to sell a vendor's product. In one embodiment, deployment tools may include one or more of a universal resource locator, a link, a widget, a blog, and a social network.

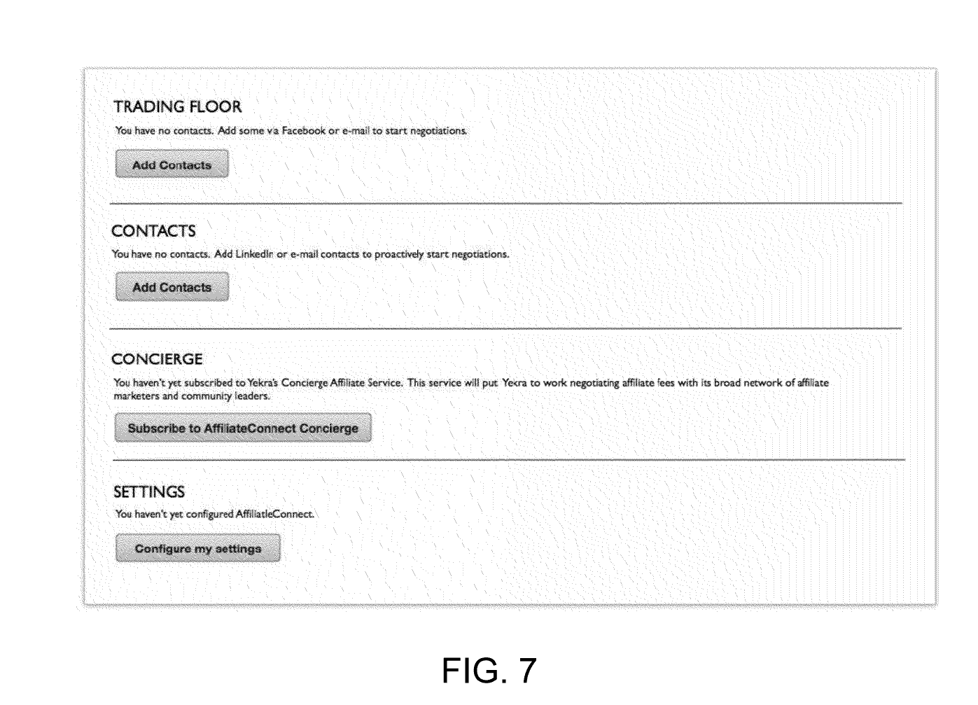

In one embodiment, the user interface module that interfaces with one or more of a vendor and a reseller. In another embodiment, the user interface module 260 may be configured to receive information from one of a vendor and a reseller. In another embodiment, the user interface module 260 may be configured to display other information to one of a vendor and a reseller. Many embodiment of potential user interfaces generated by the user interface module 260 are depicted in FIGS. 7-33.

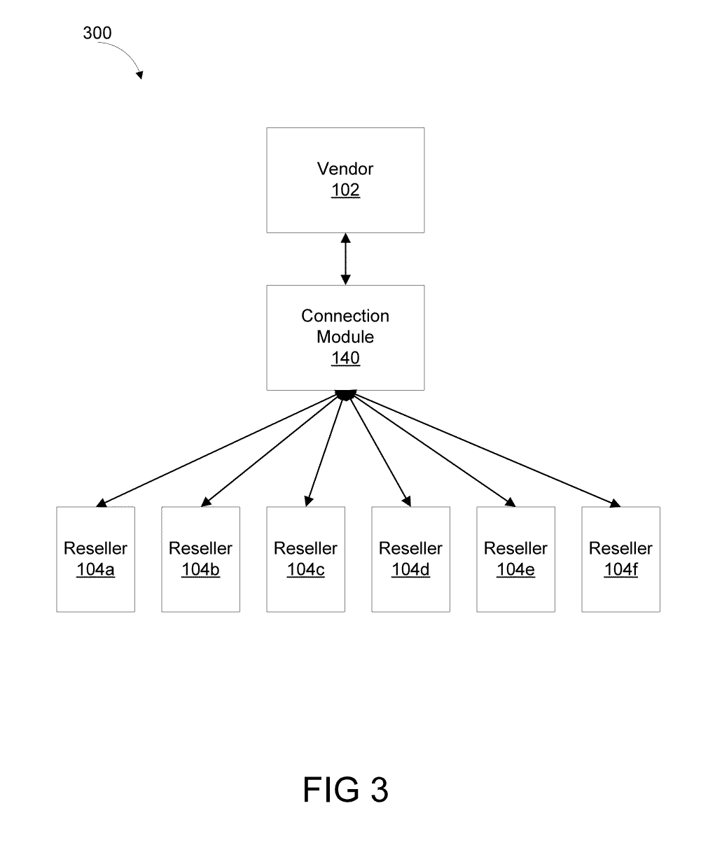

FIG. 3 is a block diagram illustrating one embodiment 300 of a system for variable commission structure affiliate sales negotiation and tracking in accordance with the present invention. The system 300 may include a vendor 102, a connection module 140 and a plurality of resellers 104. As previously described, a connection module 140 may establish connections between a vendor and the various resellers.

In another embodiment, a negotiation module 160 may negotiation different sales terms with different resellers regarding the same vendor. In one example, a negotiation module 160 may negotiate sales terms with reseller 104a, and different sales terms with reseller 104b. In one example, reseller 104c may negotiate a 5% commission sales rate, while reseller 104d may negotiate an 8% commission sales rate. In another embodiment, reseller 104e may negotiation access to a theatrical release window while reseller 104f may negotiate access to a general release window. If course, other arrangement may be made by the negotiation module as one skilled in the art may recognize. Furthermore, the system 300 may include many more affiliates than those depicted in FIG. 3.

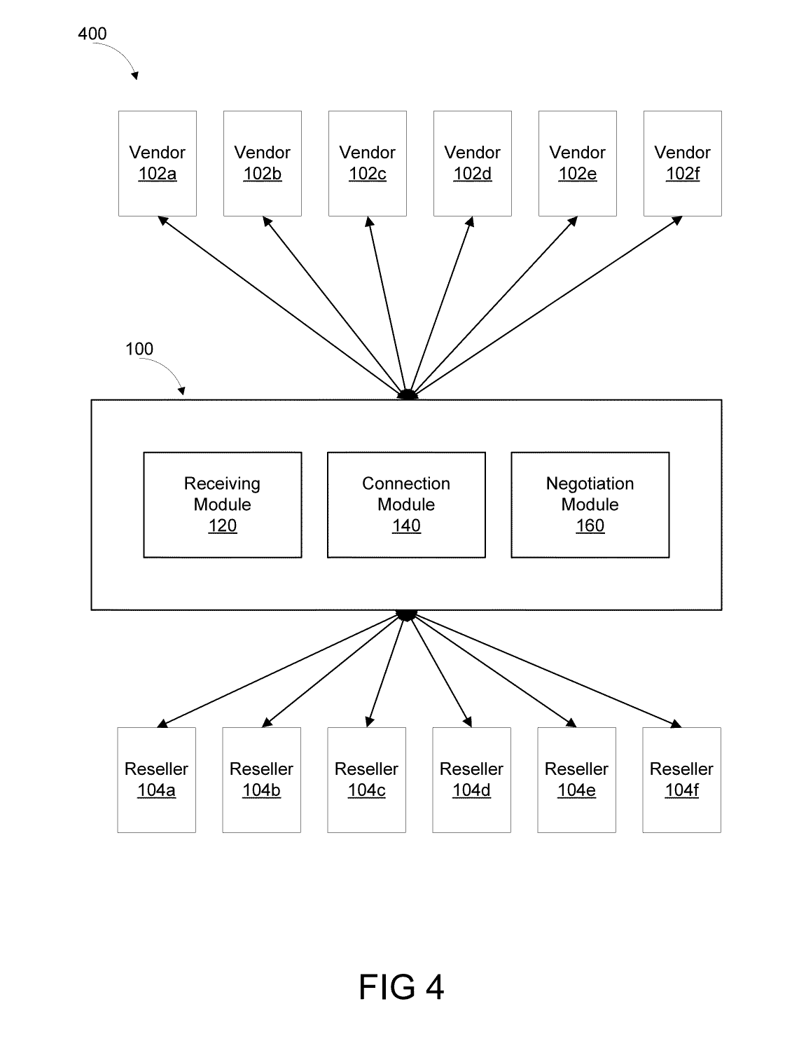

FIG. 4 is a schematic block diagram illustrating one embodiment of a system for variable commission structure affiliate sales negotiation and tracking in accordance with the present invention. In one embodiment, the system may include a plurality of vendors 102, an apparatus 100 according to one embodiment of the present invention, and a plurality of affiliate resellers 104. In one embodiment, a receiving module 120 may receive many sales terms upon which a vendor's 102a product may be made available for resale. In another embodiment, a receiving module 120 may receive sales terms from many vendors 102 or content owners 102. Therefore, the apparatus 100 may store offered sales terms for various products or services made available by many different vendors.

In another embodiment, a connection module 140 may connect one or more vendors 102 to one or more affiliate resellers 104. In one embodiment, the connection module may connect one vendor 102a to multiple affiliate resellers 104a, 104b, 104c, 104d, 104e, 104f. For example, a connection module 140 may connect vendor 102b, to reseller 104d and reseller 104e. In another embodiment, a connection module 140 may connect a single affiliate reseller 104 to multiple vendors 102. For example, a connection module 140 may connect affiliate reseller 104f to vendor 102b and vendor 102c.

In one embodiment, the connection module 140 may connect vendors 102 to resellers 104 based on sales terms. In another embodiment, a vendor 102a may offer sales terms including a 10% base commission rate. The connection module 140 may connect the vendor to affiliate resellers that have requested to work with vendors offering 10% or higher base commission rates. In another example, an affiliate reseller may request to work with vendors offering exclusive availability to a theatrical release for a media content. In this example, a vendor may offer a media content and include exclusive access to a theatrical release. In this example, a connection module 140 may connect the vendor and the affiliate reseller based on the sales term including exclusive access to a theatrical release. Of course, other availability windows may be used, such as, but not limited to, various availability windows disclosed herein, and this disclosure is not limited in this regard.

In one embodiment, a negotiation module 160 may negotiation between one or more vendors 102 and one or more affiliate resellers 104. In one embodiment, a vendor 102a may offer sales terms for a content, and may include a required performance threshold in the sales terms. Therefore, in this embodiment, a negotiation module 104 will decline offers with modified sales terms from affiliate resellers that do not meet the performance threshold.

In one example, a receiving module 120 may receive a sales offer from a vendor 102a that includes a performance threshold that only affiliate resellers with more than $100,000 in sales may negotiate sales terms. Therefore, in this example, if affiliate reseller 104a has $80,000 in sales, affiliate reseller 104a may accept the original sales terms supplied by the vendor 102a. If affiliate reseller 104b has $140,000 in sales, reseller 104b may also accept the original sales terms. Another affiliate reseller 104c may have $170,000 in sales, and may submit a counter offer to the negotiation module 160. The negotiation module 160 may accept the counter offer and transmit the sales terms in the counter offer to the vendor for approval or denial. Affiliate reseller 104d may have $99,000 in sales, and may also submit a counter offer to the negotiation module 160. In this example, the negotiation module 160 may deny the counter offer from the affiliate reseller 104d that has not met the required performance threshold.

In another embodiment, the performance threshold may include performance over a period of time. For example, a performance threshold may include $100,000 in sales over the past year. Of course, other time periods may be used and this disclosure is intended to cover all such time periods. In another embodiment, the performance threshold may include sales with a specific vendor. For example, a performance threshold may include $10,000 in sales with vendor 102a. Furthermore, a performance threshold may include other parameters previously described, such as, but not limited to a size of an email list, a number of followers, a number of website visits, total sales figures, and previous sales with a specific vendor.

In another embodiment, a connection module 140 may be configured to search for additional resellers in response to a request from a vendor. For example, if current available resellers do not meet a performance threshold, a vendor may request that the connection module 140 search for additional resellers. In one example, a connection module 140 may search for additional resellers by querying a remote database, emailing potential resellers, calling potential resellers, or otherwise contacting other resellers and requesting them to register with the apparatus 100. In another embodiment, a connection module 140 may request that another user of the apparatus search for additional potential resellers. In another example, a connection module 140 may be configured to request additional resellers in response to a low threshold of offers not being met.

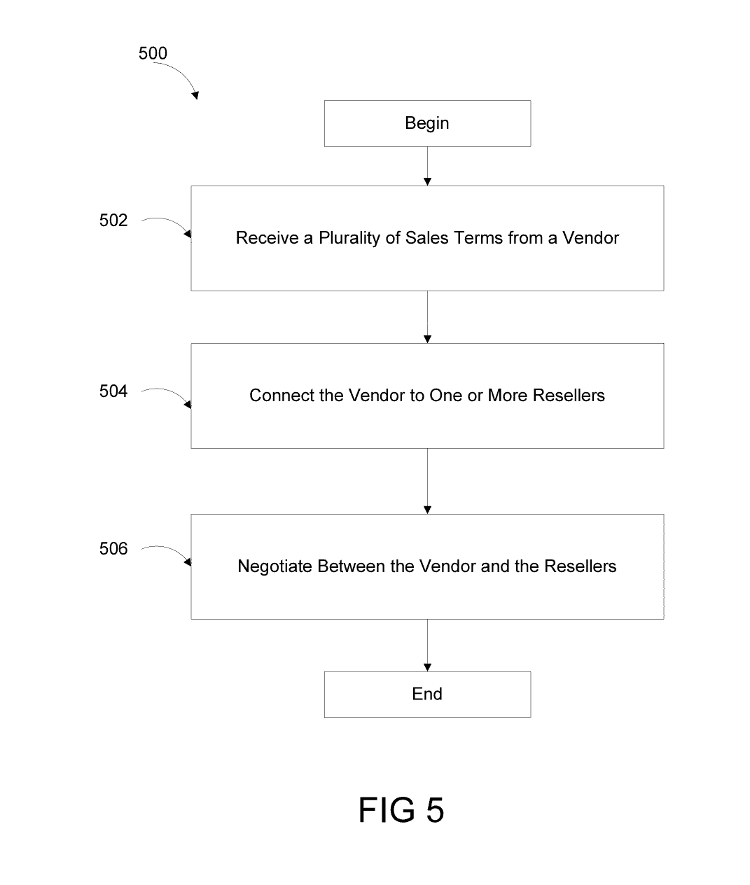

FIG. 5 is a flow chart diagram illustrating one embodiment of a method 500 for variable commission structure affiliate sales negotiation and tracking in accordance with the present invention.

In one embodiment, the method 500 may begin and a device implementing the method 500 may receive 502 a plurality of sales terms form a vendor. A device implementing the method may connect 504 the vendor to one or more resellers. A device implementing the method may negotiate 506 between the resellers and the vendors and the method 500 may end.

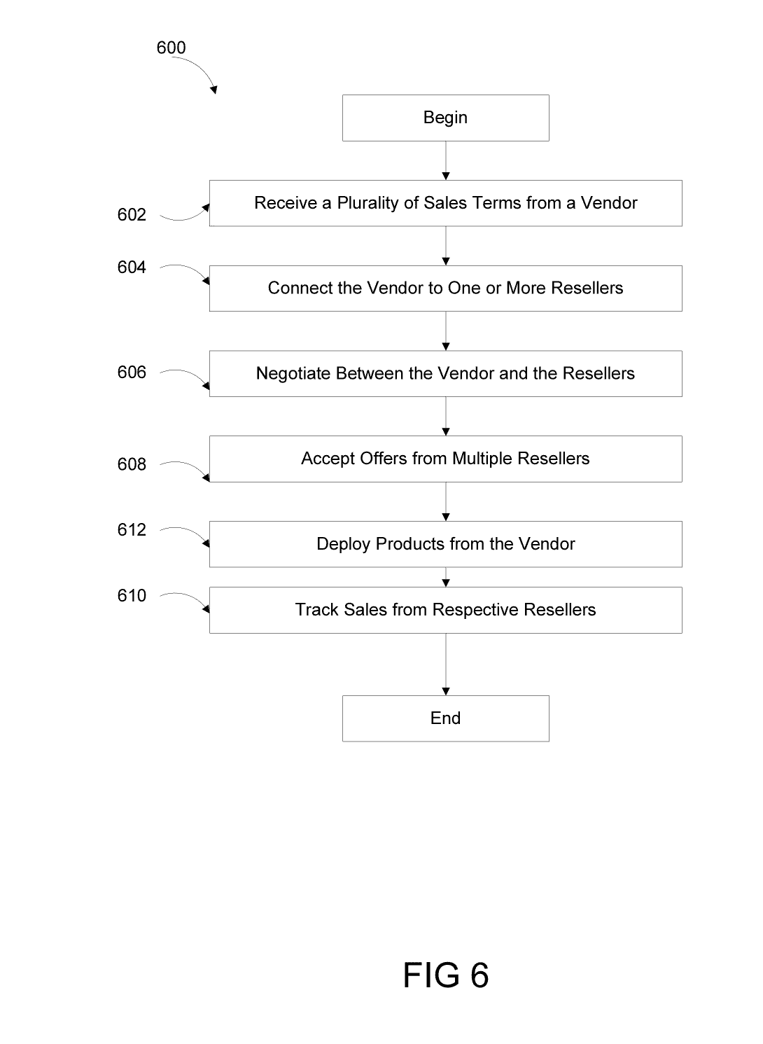

FIG. 6 is a flow chart diagram illustrating one embodiment of a method 600 for variable commission structure affiliate sales negotiation and tracking in accordance with the present invention.

In one embodiment, the method 600 may begin and a device implementing the method 600 may receive 602 a plurality of sales terms from a vendor. A device implementing the method 600 may connect 604 the vendor to one or more resellers. A device implementing the method 600 may negotiate 606 between the vendor and the resellers. A device implementing the method 600 may accept 608 offers from multiple resellers. In one embodiment, the accepted offers may be different from each other. A device implementing the method 600 may deploy 612 one or more products from the vendor. A device implementing the method 600 may track 610 sales from the multiple resellers and the method may end.

FIGS. 7 through 33 depict various embodiment of a user interface that may be displayed by a user interface module 260. Many embodiments are depicted in respective figures.

FIG. 7 depicts an embodiment of an interface for a broad overview of available features and datasets available to a vendor 102. In one embodiment, the user interface module 260 may depict an interface as depicted in FIG. 7. The user interface may include a trading floor that may include current contacts and offers associated with a vendor. The interface in FIG. 7 may include a contact button for importing contact with a system displaying the interface in FIG. 7. Furthermore, additional services may be presented via a button on the interface in FIG. 7. In one example, a “Concierge” service may be initiated via an interface. A “Concierge” service may substantially include capabilities by an apparatus 100 for connecting vendors 102 and resellers 104, as described herein. The interface in FIG. 7 may also include a settings area where an affiliate reseller may contact the vendor 102.

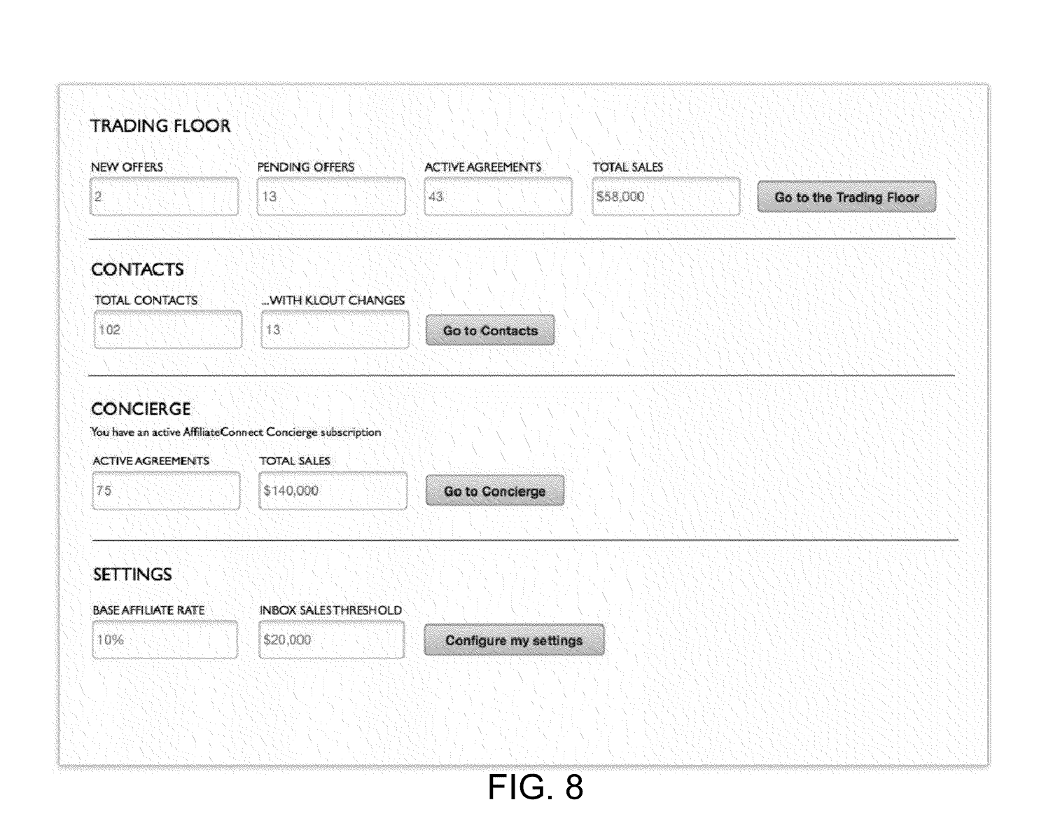

FIG. 8 is an embodiment of an interface for a broad overview of available features and datasets available to a reseller. In one example, the user interface module 260 may display an interface displaying pending offers, active agreements, and actual affiliate sales, or other overview numbers for a vendor. A user of such an interface may also specify a performance threshold, such as a base rate or a sales amount before a reseller may contact the vendor.

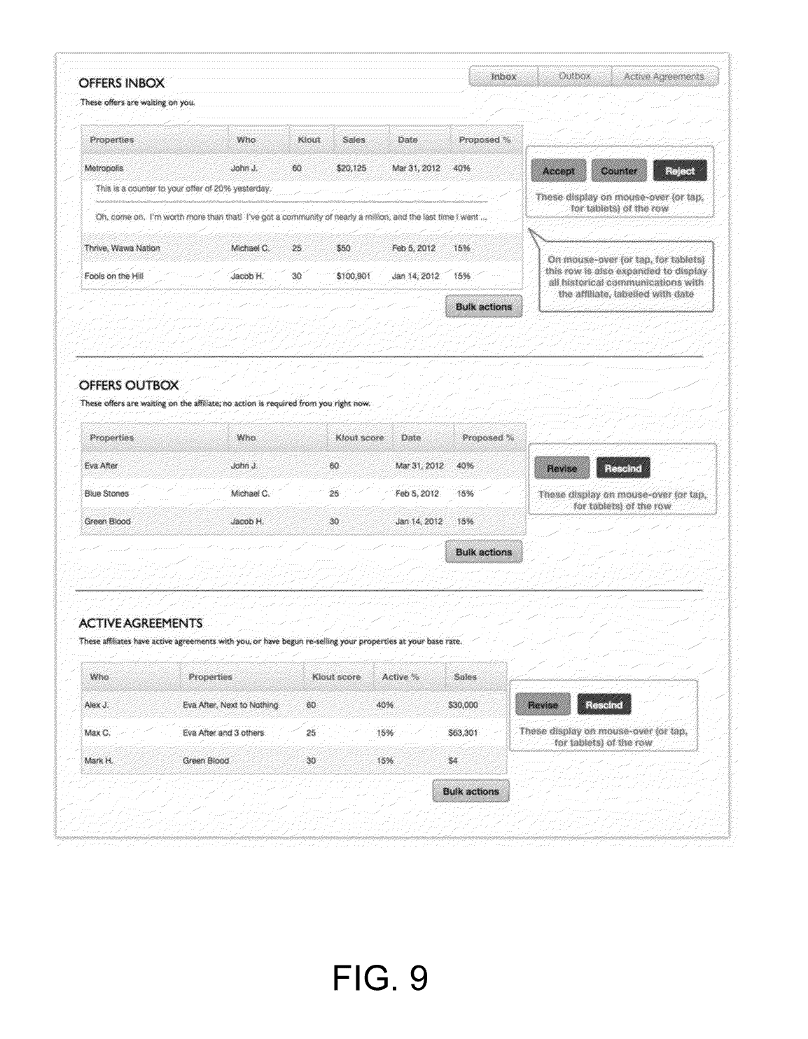

FIG. 9 is an illustration of a user interface available to a vendor. A user interface module 260 may include an interface that may display an offers inbox that includes offers received from a reseller. The interface may display an offers output box that displays offers or counteroffers submitted to resellers. The display may also depict current agreements with resellers.

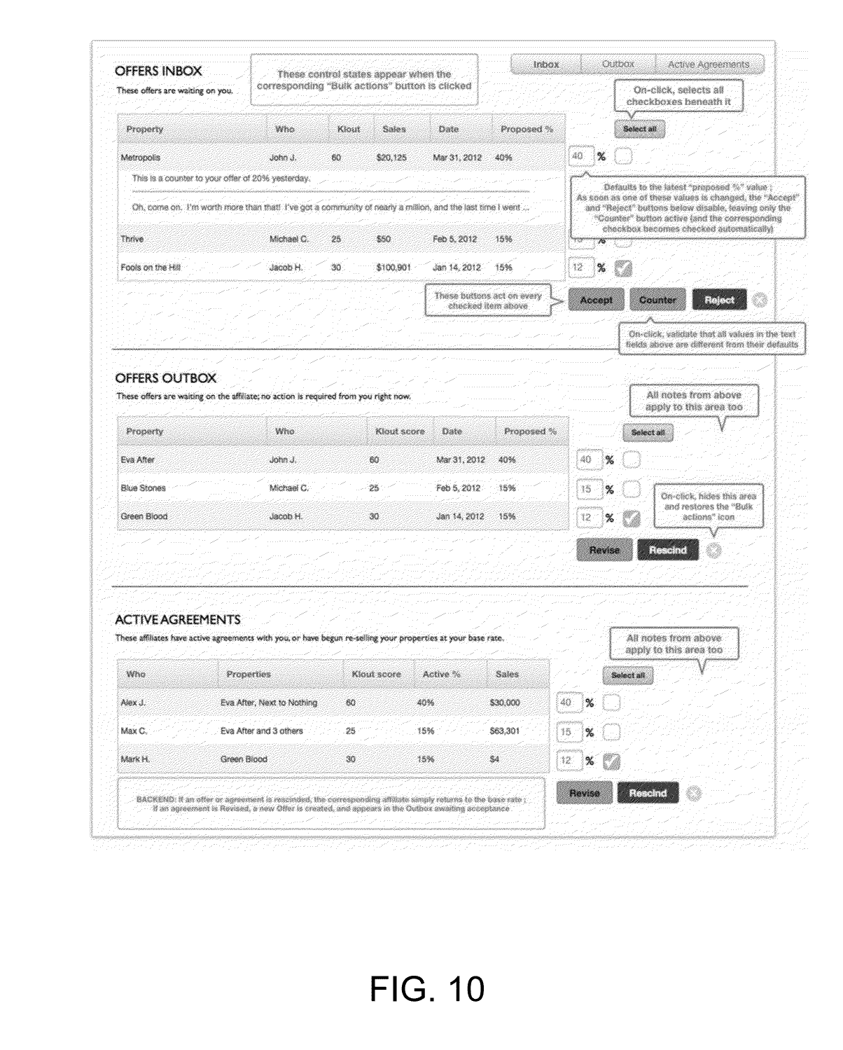

FIG. 10 is an illustration of one possible user interface for the available functions surrounding negotiation. An interface may display an offers inbox, an outbox, and a summary of active agreements may be displayed by a user interface module 260. Using this interface, a vendor may submit counter offers for multiple offers, or accept multiple offers using one click.

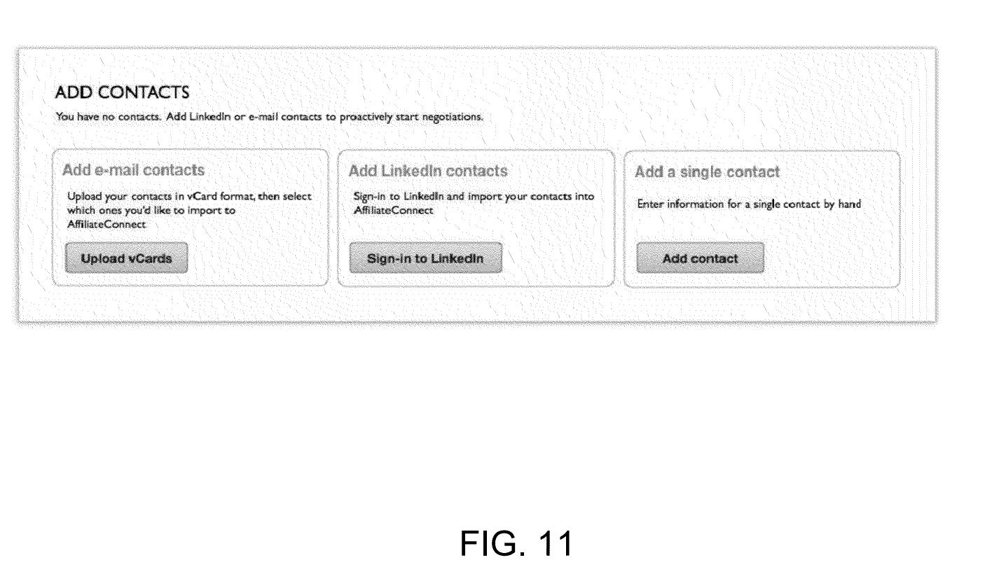

FIG. 11 is an illustration of some possible functional options for importing contacts. In one embodiment, a user interface module 260 may receive a list of contact from a user, authenticate to a social network service, or add a contact by receiving information regarding the contact.

Then moving onto FIG. 5, this is the contacts area where content owners can try to leverage their own networks in addition to our existing network and one of the nice things . . . I don't know if this has a lot of bearing on the patent, but it is part of the business model that surrounds it is that we do bring in new affiliates from every content owner that comes in. So we are aggregating affiliate resellers. We go out and find them ourselves. We also get them from content owners as they come in here and upload their contacts and send out offers. Anyone who accepts an offer and begins reselling for that content owner becomes one of our Affiliate Connect resellers who we can then leverage in the future. So it is an ever growing network.

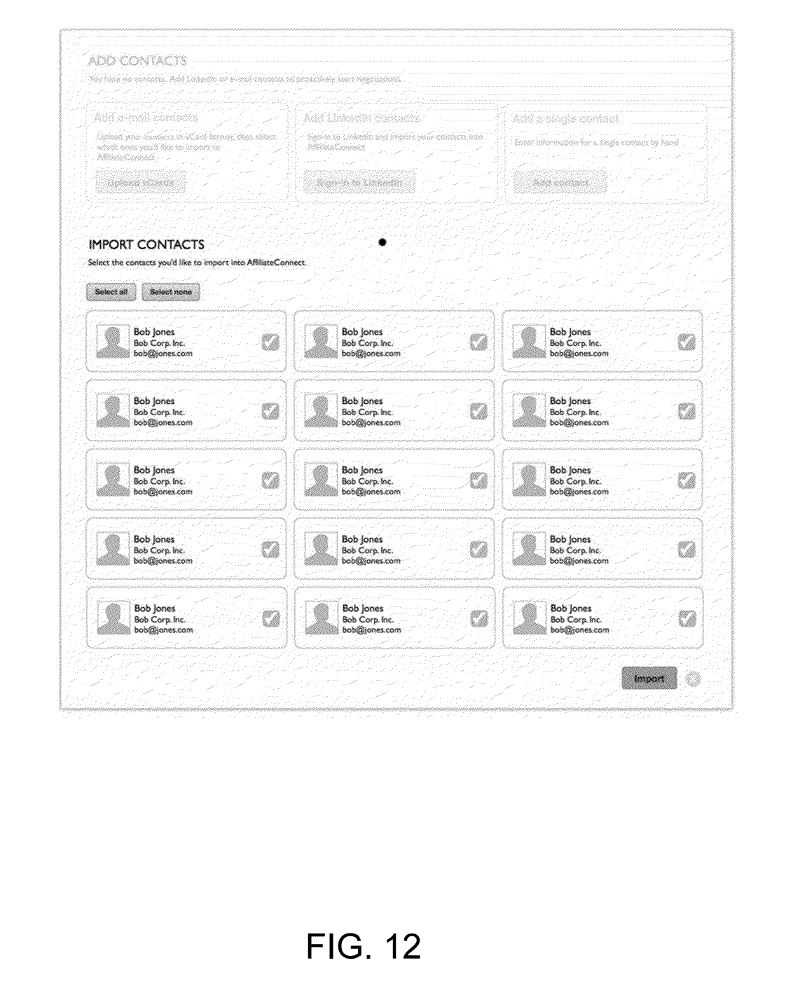

FIG. 12 is an illustration of one possible interface for selecting contacts to import. FIG. 12 depicts one embodiment of a user interface after a user imports contacts. The interface also allows a user to add, remove, or edit contacts in their network. Such an interface may allow a vendor with a current network of affiliate resellers to integrate the apparatus 100 into their current operating procedures. In another example, a vendor 102 may initiate a project and raise funds, and may want to subsequently integrate the project into an apparatus 100. Therefore, a content owner may bring a contact list and an initial content and the apparatus 100 may assist the vendor to market the content and connect with multiple affiliate resellers.

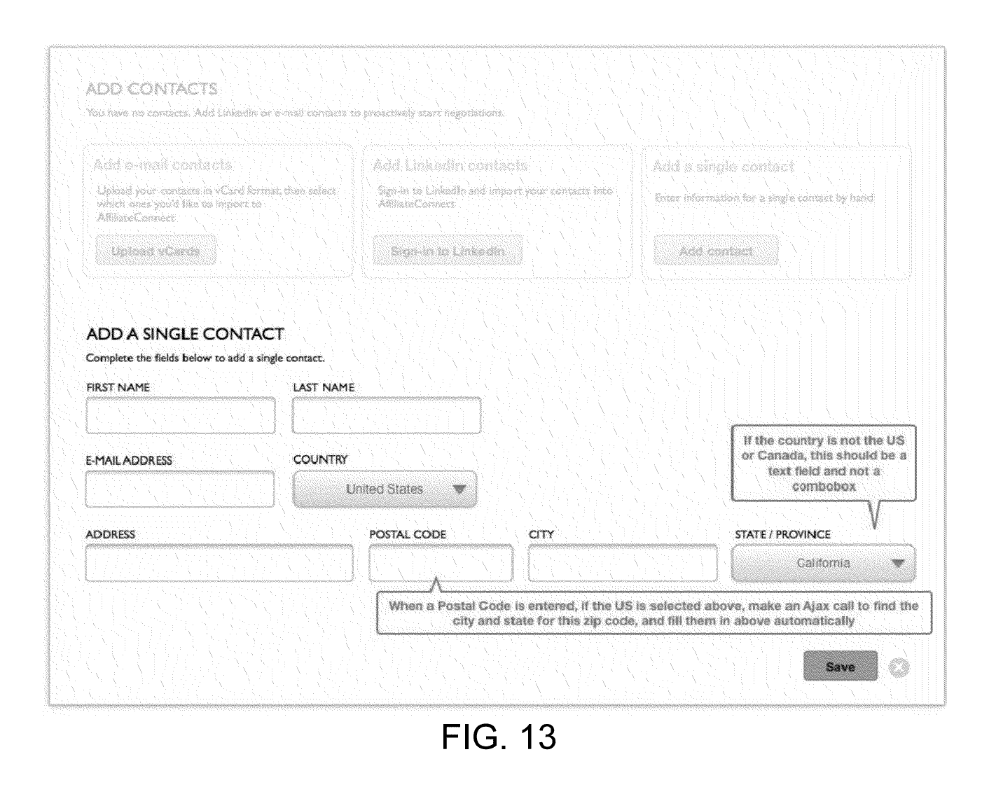

FIG. 13 is an illustration of a user interface for adding a single contact in accordance with one embodiment of the present invention.

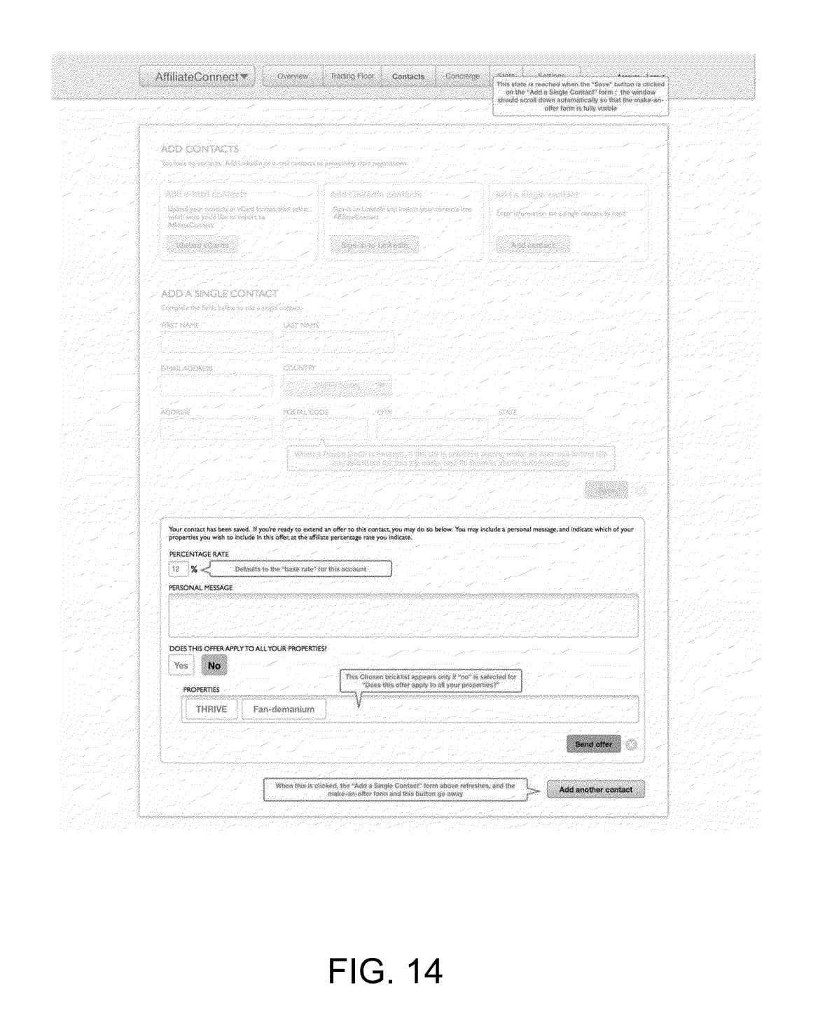

FIG. 14 is an illustration of one possible interface for sending an invitation and making an offer. The interface depicted in FIG. 14 depicts one embodiment of an interface for receiving an offer from a vendor or a content owner. Furthermore, such an interface may receive adjustments to current offers from a vendor 102.

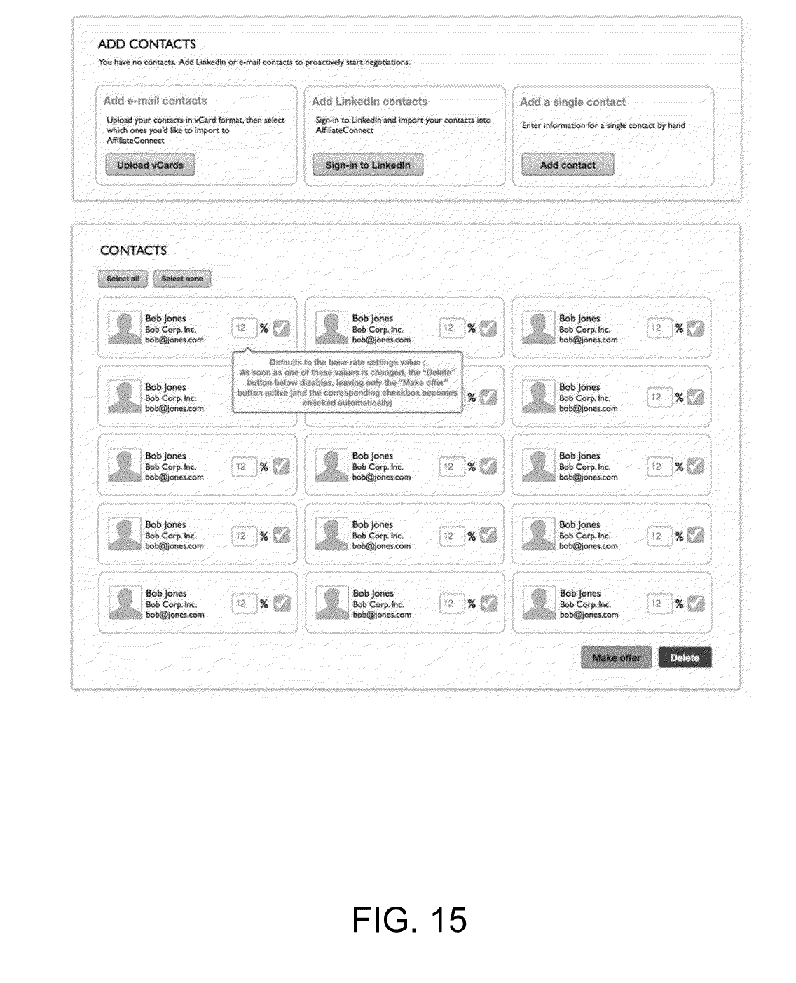

FIG. 15 is an illustration of one possible interface for selecting multiple contacts. The interface may receive multiple offers from a vendor and submit the offers to the selected affiliate resellers as indicated in the interface.

In one interface, a user may enter information and select contact to make offers to. An apparatus, such as apparatus 100, may receive different commission base rate amount for different contacts from a vendor, and submit the offers to the apparatus 100. In response, a negotiation module 160 may make the submitted offers to indicated resellers.

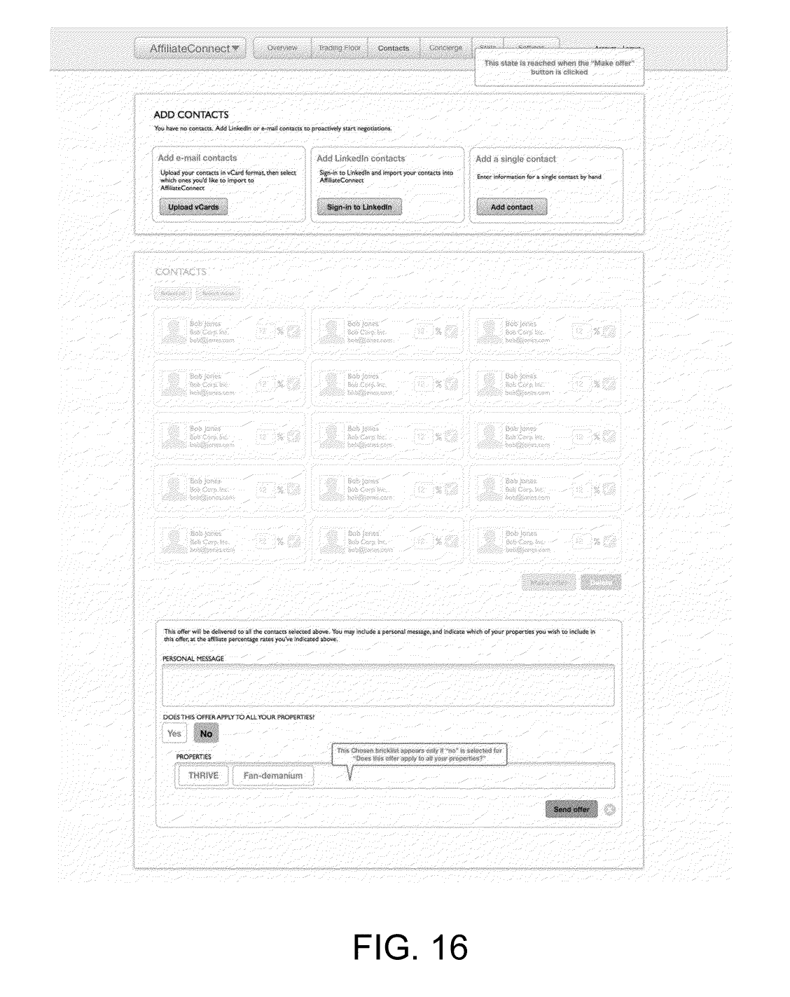

FIG. 16 is an illustration of one possible interface for sending invitations. The interface in FIG. 16 may include means for receiving a personal message from a vendor, and including the message in offers submitted to resellers. Therefore, in one embodiment, a negotiation module may include a personal message in an offer or a counter offer. The personal message may include an invite for a reseller to offer on other available media content. The personal message may also include a link to allow a reseller to accept the offer.

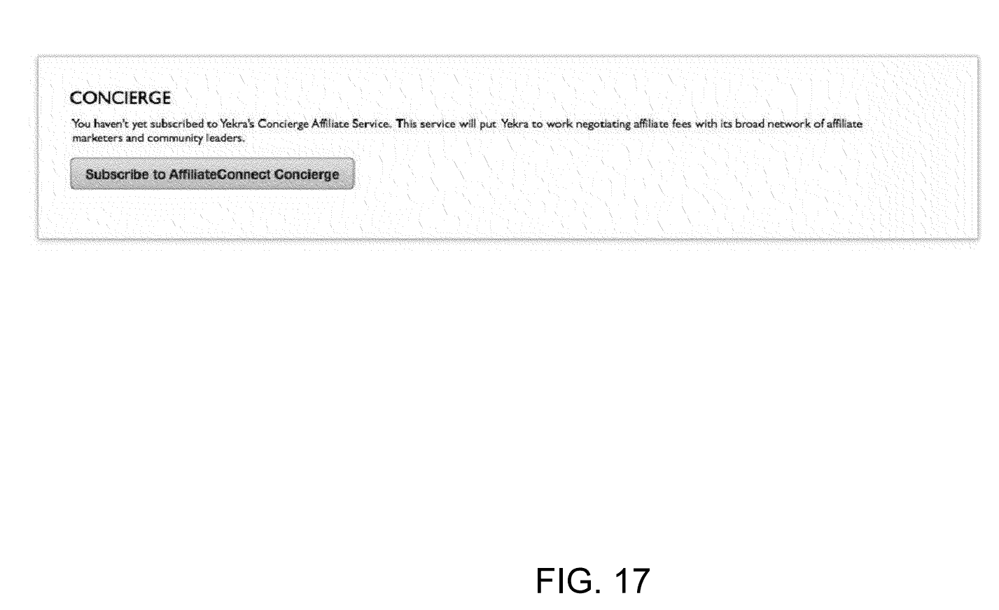

FIG. 17 is an illustration of one possible interface for a vendor to activate a service. The interface, according to FIG. 17 may include a button to activate the service.

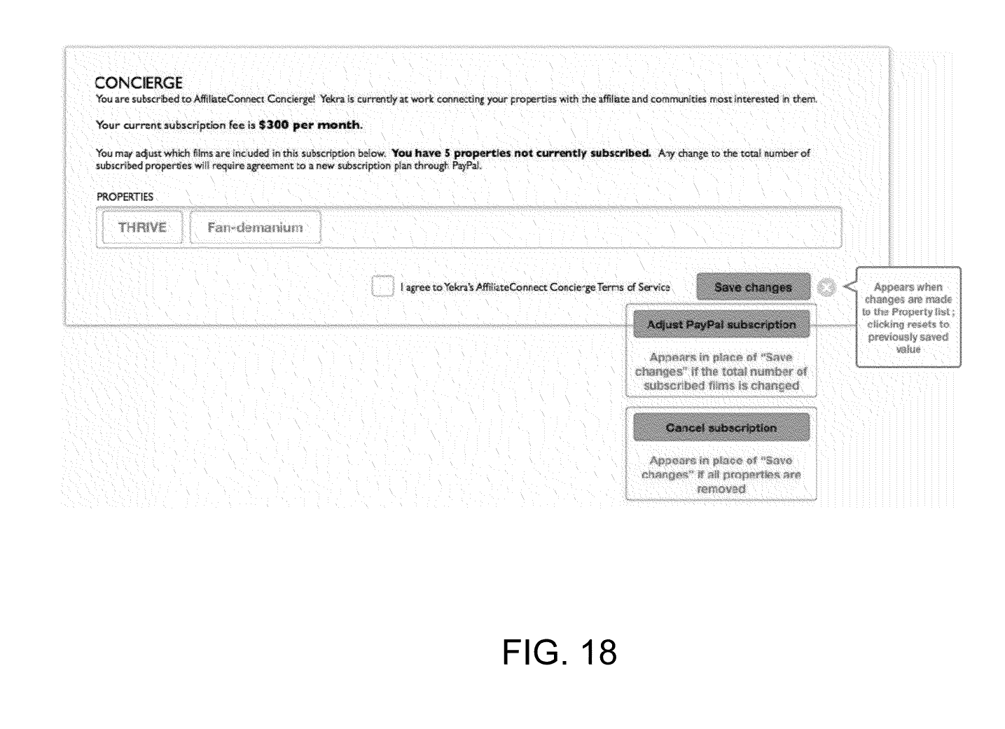

FIG. 18 is an illustration of one possible interface for modifying which products have been selected by a vendor. In one embodiment, an interface may indicate a fee for a service. In one example, the interface may indicate that the fee is $300 per month for a “Concierge” service. The interface may also indicate a set of contents, or properties being managed by the apparatus 100.

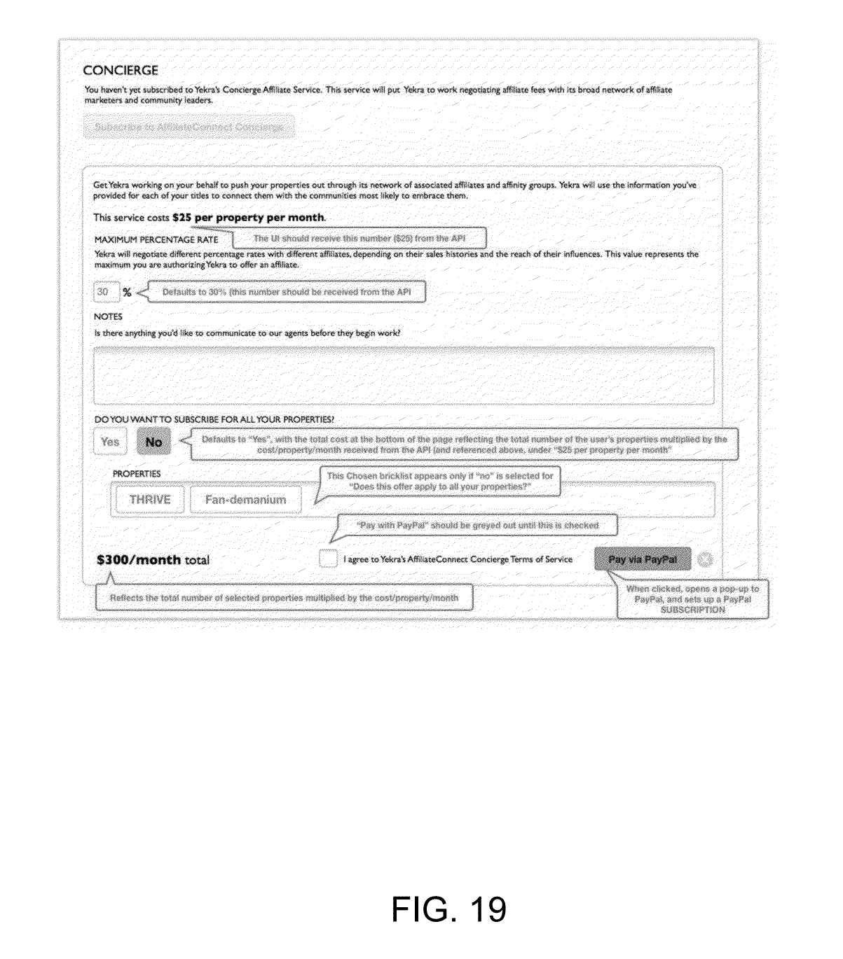

FIG. 19 is an illustration of one possible interface for selecting multiple products to activate. In one embodiment, the interface may display an amount of money required to activate the service. Furthermore, the interface may be configured to receive a maximum negotiable base rate. For example, a negotiation module 160 may receive a maximum base rate, such as 30%. In this example, a negotiation module 160 may automatically negotiate rates with vendors up to the maximum base rate. For example, a negotiation module 160 may negotiate a rate of 26% with a vendor without seeking automatic approval from a reseller.

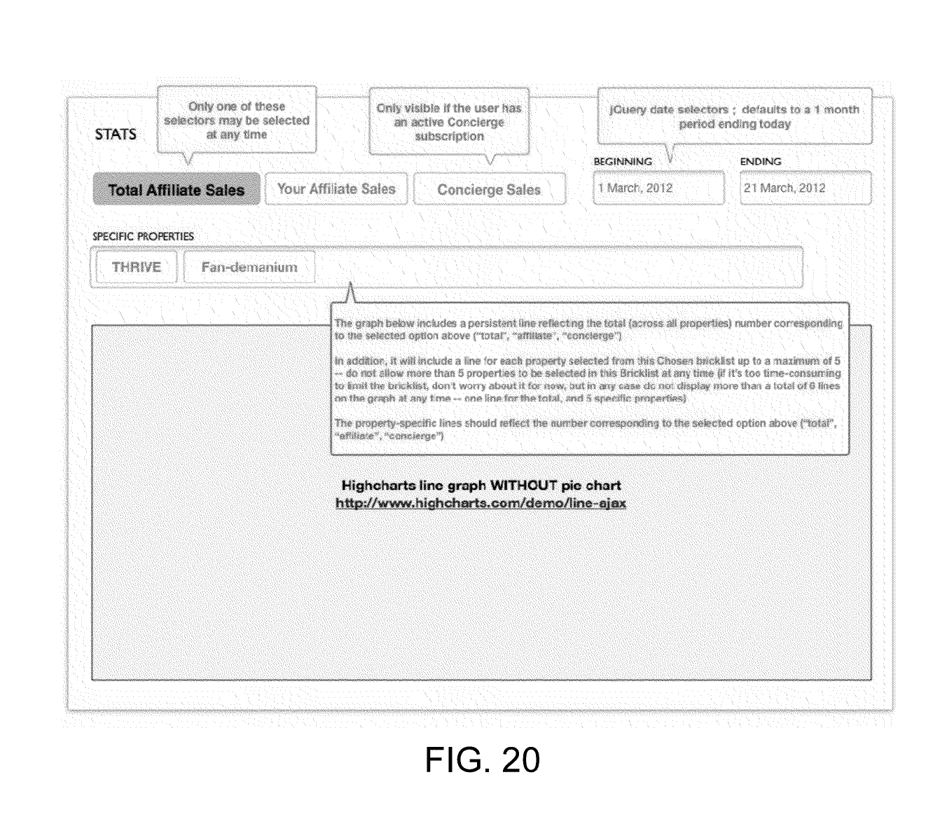

FIG. 20 is an illustration of one possible interface for providing sales statistics and reports. The interface in FIG. 20 displays a number of sales and may depict other charts to indicate status or progress of current sales activity.

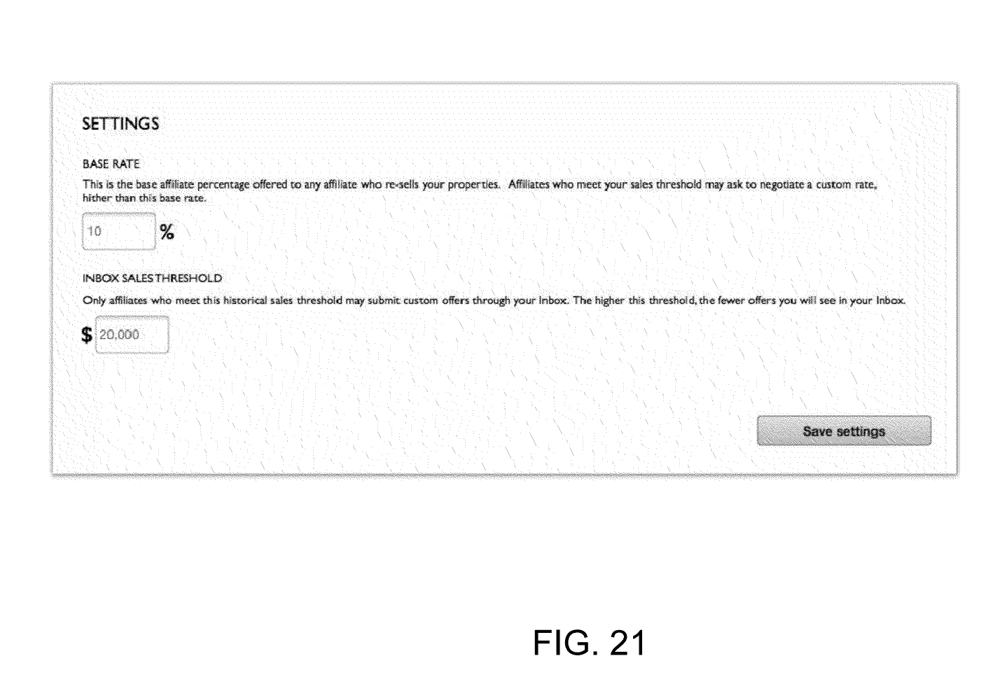

FIG. 21 depicts an embodiment of an interface for configuring global configuration settings. In one embodiment, a negotiation module 160 may display settings information, and allow a vendor or a reseller to modify various settings. Settings may include setting performance threshold values, or other, or the like.

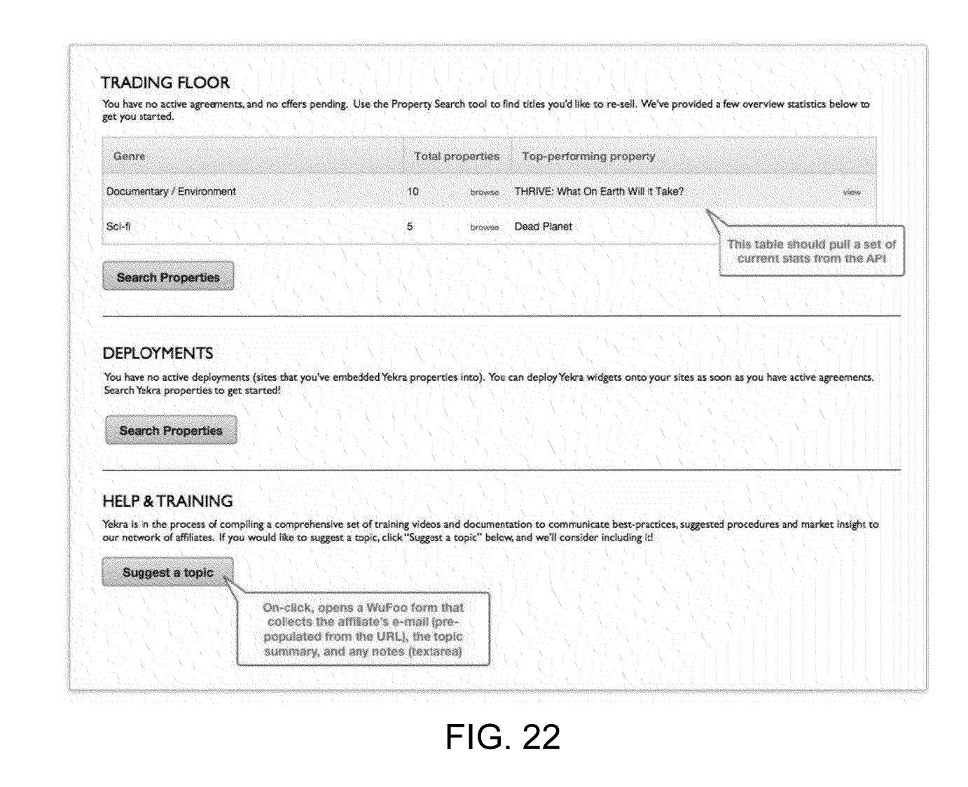

FIG. 22 is an illustration of one possible interface for the available functions surrounding negotiation and managing re-sale Agreements. In one embodiment, an interface may display overview information for an affiliate reseller. The interface may display new offers, counter offers, or other offers that may be part of the reseller's trading floor, as previously described. This interface may also display the embeddable widgets and links previously described.

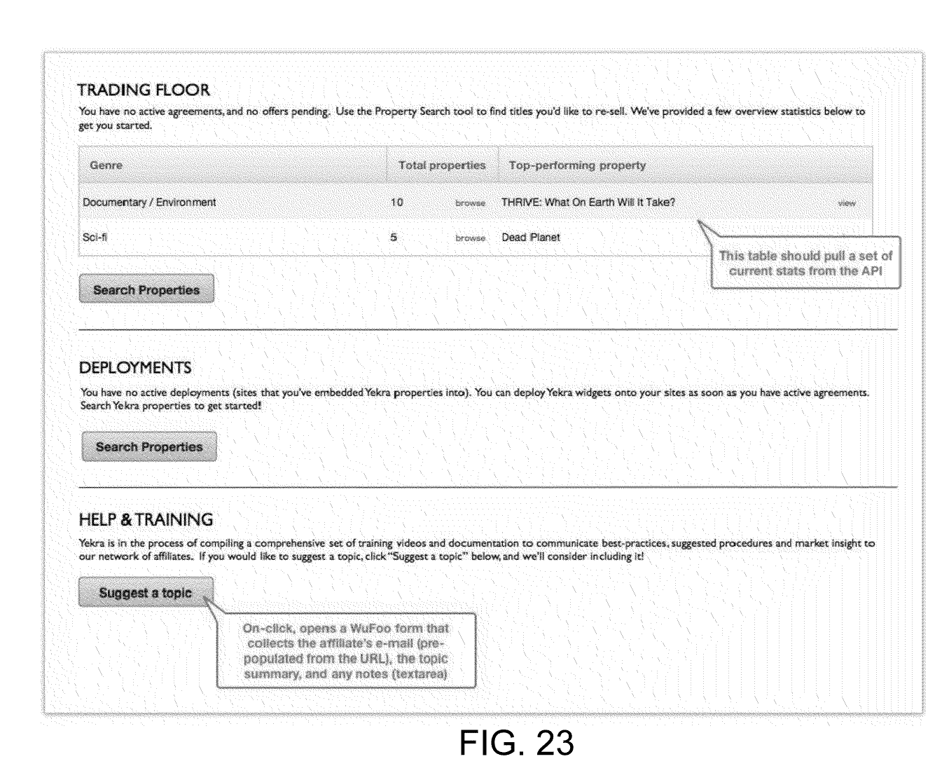

FIG. 23 is an illustration of one possible interface for an overview of available features. In one embodiment, the interface may display properties under current agreements, or provide an interface for assistance or help information.

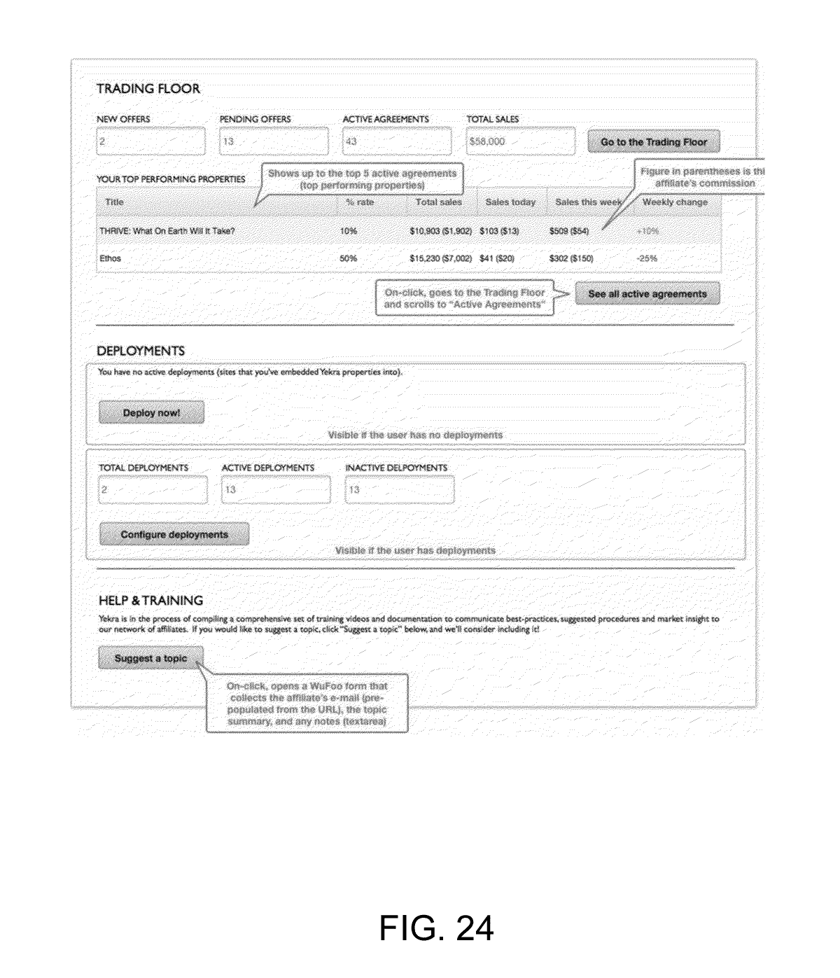

FIG. 24 is an illustration of one possible interface for manage existing re-sale agreements. In one embodiment, the interface may be used to request embed codes or links. In one embodiment, the provided link may be a click-through agreement. The interface may include an inbox for offers or counter offers, active agreements, money earned, or the like. In another embodiment, provided links, widgets, or the like, may be used by a reseller to sell the product.

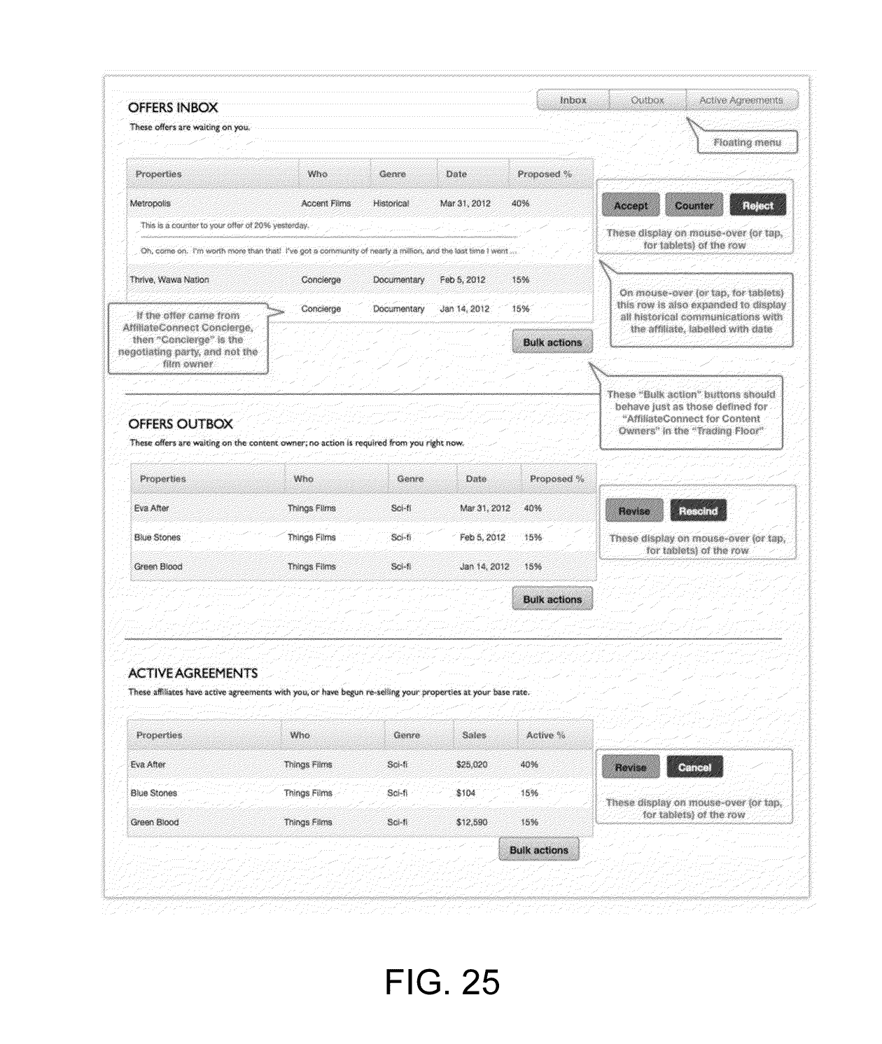

FIG. 25 is an illustration of one possible interface for managing existing product Deployments. In one embodiment, the interface may be used to add a deployment. Furthermore, a user may use the interface to indicate how a vendor's product will be sold or advertised.

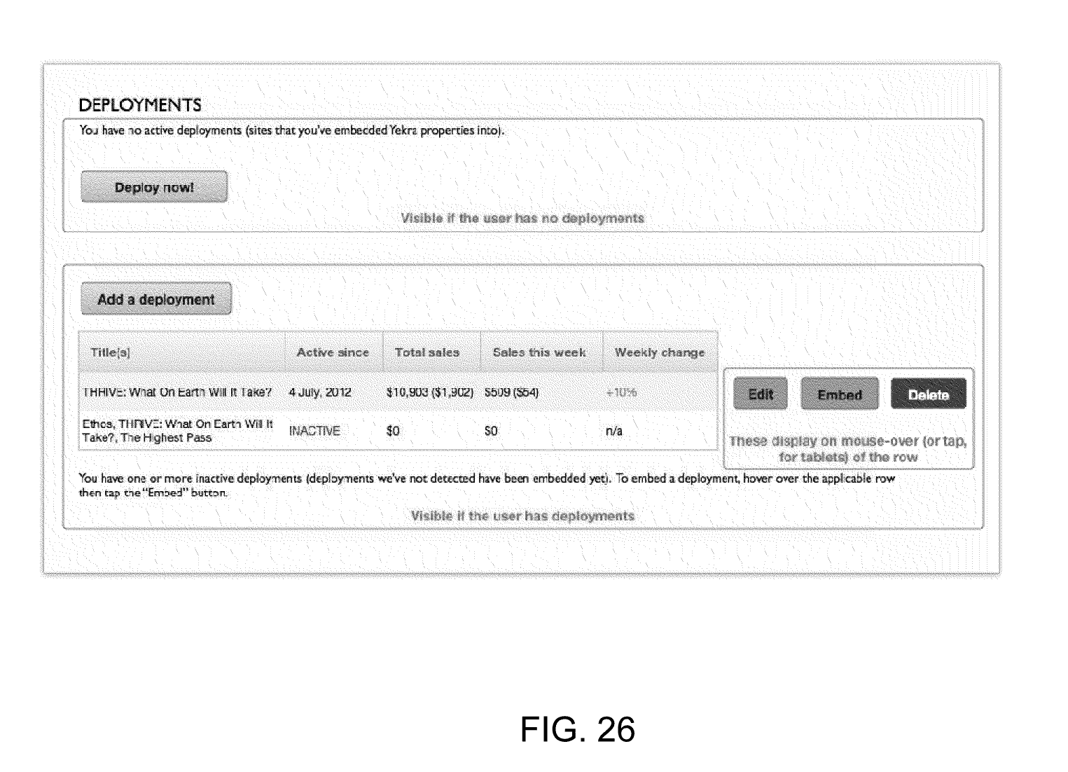

FIG. 26 is an illustration of one possible interface for retrieving “embed codes” for an existing product deployment. In one embodiment, a list of deployments may be displayed. With respective deployments, an “embed” button may be displayed, where when clicked, causes the apparatus 100 to display an embed code for the related deployment.

In another embodiment, a “deploy” button may be displayed. An affiliate reseller may click a “deploy” button in response to an agreement being reached with a vendor. Therefore, in one embodiment where an affiliate reseller has come to an agreement with several different vendors, separate “deploy” buttons may be presented for respective agreements. In one example, an affiliate reseller may come to an agreement with several different vendors, and deploy separately for each content. For example, in one deployment, one vendor's content may be deployed through an internet advertising service. In another example, a vendor's content may be deployed through radio advertising. In another example, another vendor's content may be deployed through a widget provided by the apparatus 100.

In one embodiment, an affiliate reseller may track results for each of the deployments. In one example, a deployment through an internet advertising service may be more effective than advertisement via a radio station. In response to tracking, an affiliate reseller may adjust deployment strategies, via an interface such as one depicted in FIG. 26. In one example, an affiliate reseller may change the deployment with the radio station to a deployment with the internet advertising service. This may allow an affiliate reseller to monitor and adjust advertising strategies real-time and based on actual live results.

In one example, an affiliate reseller may run a comic book fan site. The reseller may agree to deploy a set of movie titles related to comics. The reseller may then offer the set of movie titles on his/her web page immediately after agreeing with respective vendors of the movie titles. A widget provided at the apparatus 100 may provide this functionality. Based on agreements with respective vendors, an affiliate reseller may offer the movie titles in different ways.

In one example, the affiliate reseller may set up a single widget to sell a single movie. In another example, the affiliate reseller may create multiple deployments for multiple moves and track them separately through different sales outlets. In another example, an affiliate reseller may aggregate multiple properties in a single widget and offer them as a bundle or as a thematic collection to users in the context of his/her website, server, product lines, or the like.

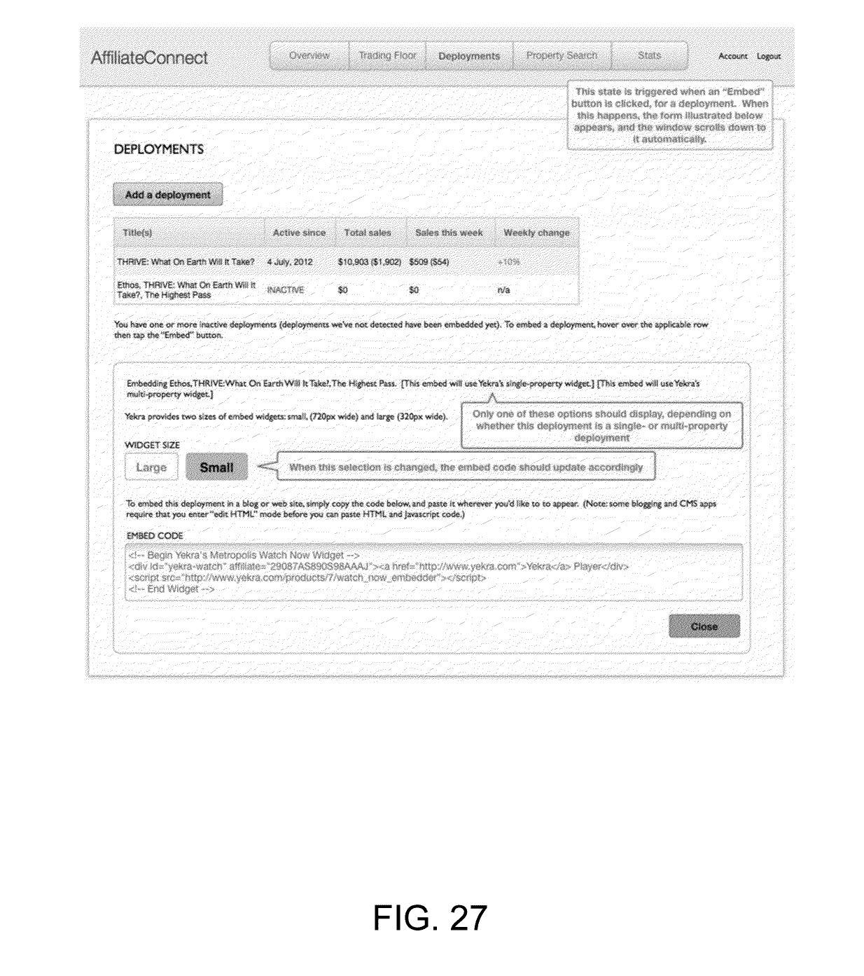

FIG. 27 is an illustration of one possible interface for configuring a new product deployment. In one embodiment, an affiliate reseller may begin making deployment decisions. The affiliate reseller may indicate these decisions via the interface depicted in FIG. 27. The affiliate reseller may indicate properties to represent and/or sell. The affiliate reseller may configure a search via the interface. In response to input from the affiliate reseller, a deployment module may provide deployment tools to an affiliate reseller.

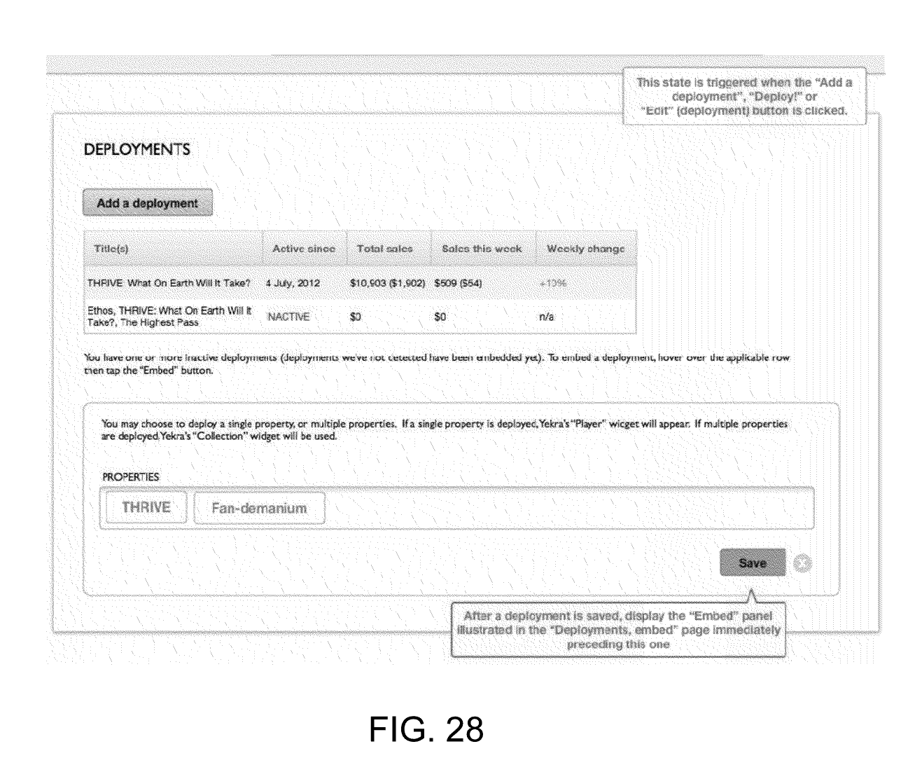

FIG. 28 is an illustration of one possible interface for configuring a new product deployment. In one embodiment, an affiliate reseller may begin making deployment decisions. The affiliate reseller may indicate these decisions via the interface depicted in FIG. 28. The affiliate reseller may indicate properties to represent and/or sell. The affiliate reseller may configure a search via the interface. In response to input from the affiliate reseller, a deployment module may provide deployment tools to an affiliate reseller.

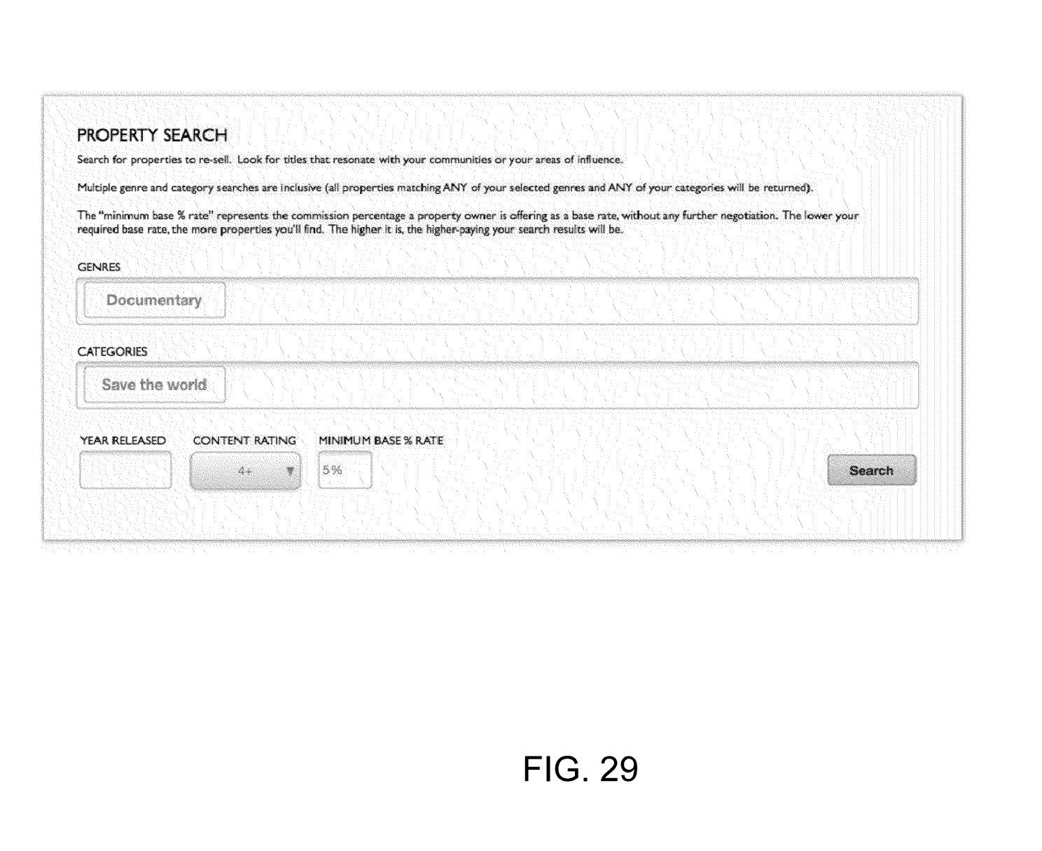

FIG. 29 depicts an embodiment of an interface for representing products that are available. In one embodiment, searching may be done based on categories and genre, or others, or the like.

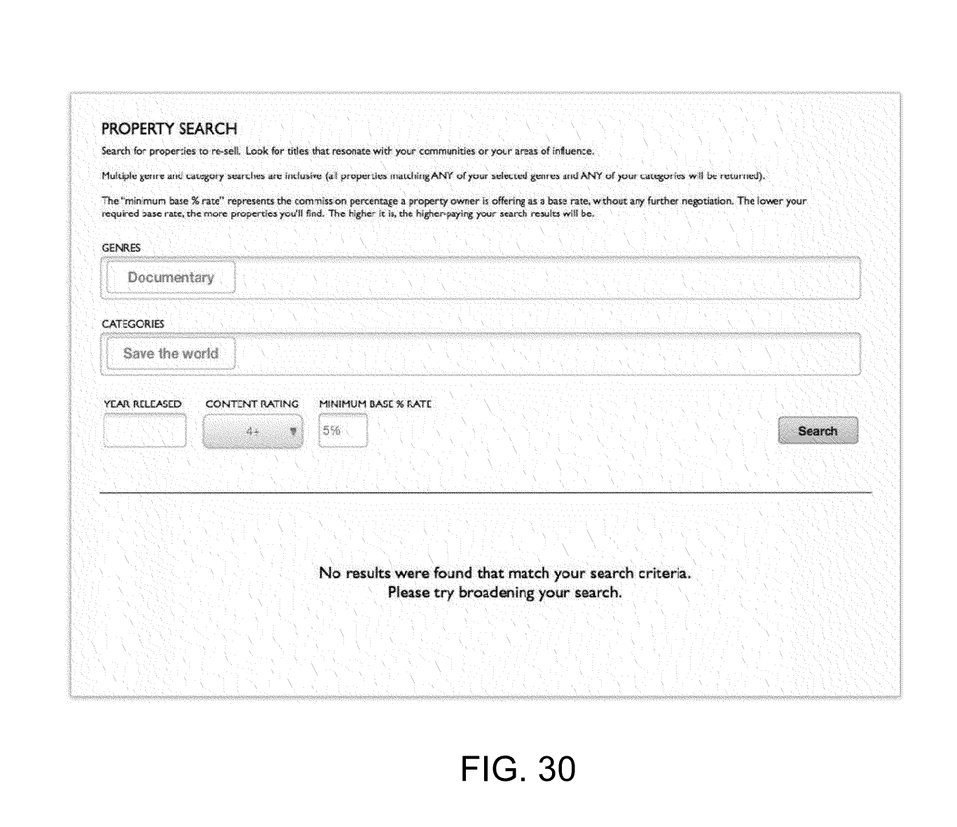

FIG. 30 depicts an embodiment of an interface for representing product search results. In one embodiment of an interface for allowing an affiliate to search vendor-configured products, in order to identify products the affiliate may wish to re-sell. In one embodiment, the interface may allow an affiliate reseller to search for a product based on one or more of a release time, a content rating, and a minimum base rate.

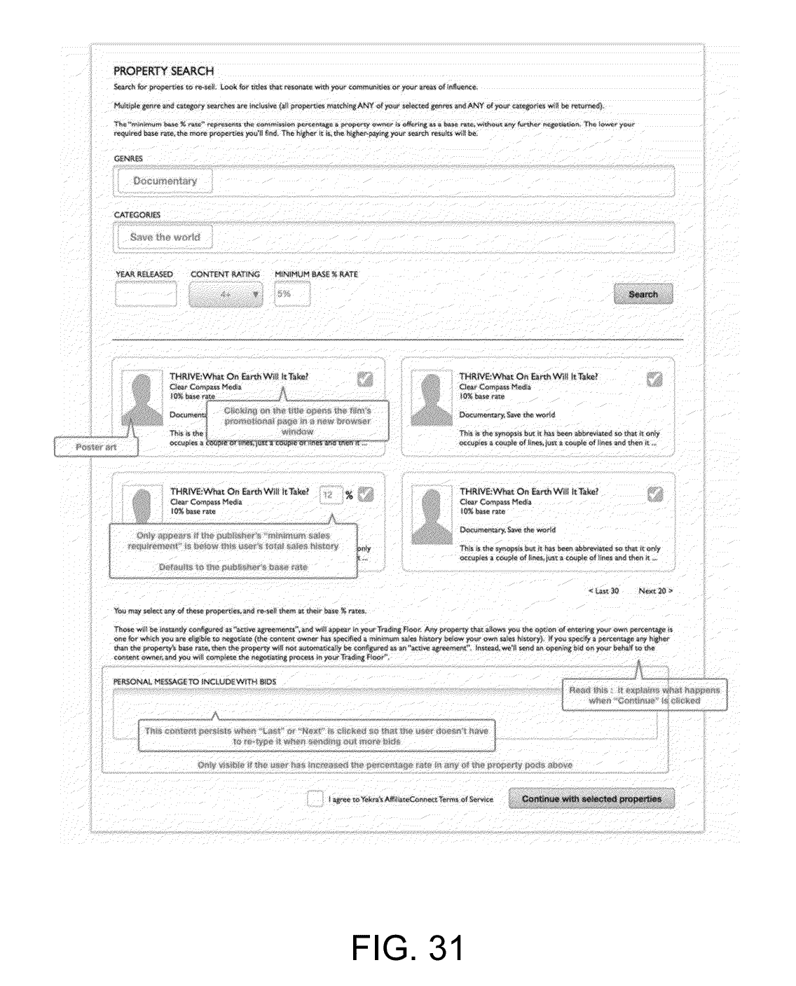

FIG. 31 depicts an embodiment of an interface for representing product search results. In one embodiment, search results are found and depicted in a table. Of course, other formats may be used and this disclosure is not limited in this regard. Properties matching a search criteria

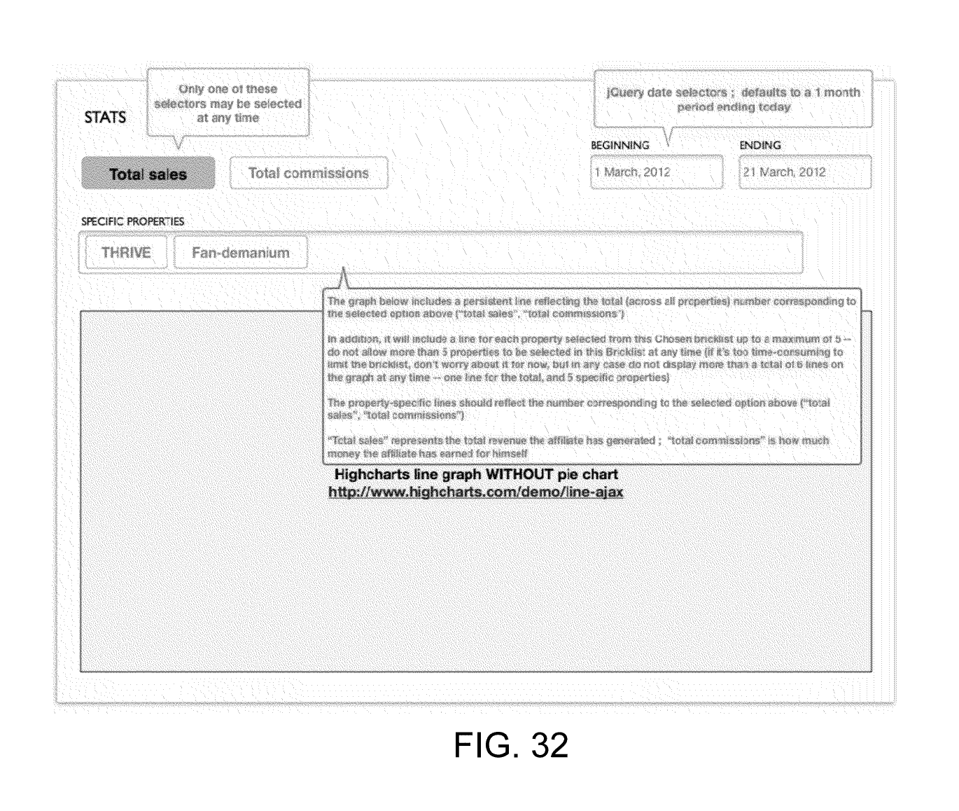

FIG. 32 is an illustration of one possible interface for representing sales figures. Such an interface may present statistics and allow a reseller to track data points, or similar.

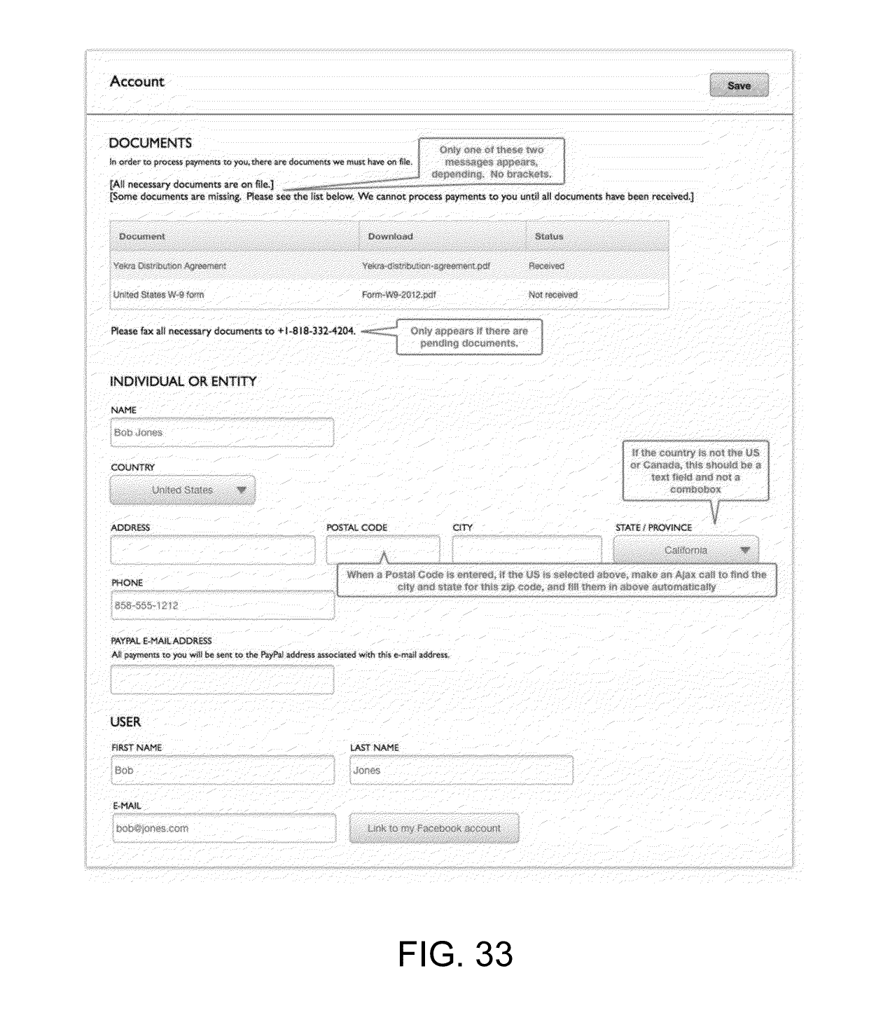

FIG. 33 is an illustration of one possible interface for managing his account and user settings. In one embodiment, documents may be tracked associated with a deployment. Documents may include documents received from affiliate resellers or publishers. Newer versions of documents may be submitted and signed by parties involved, such as affiliate resellers or vendors. This may facilitate automated agreement between parties using an online, digital document management system.

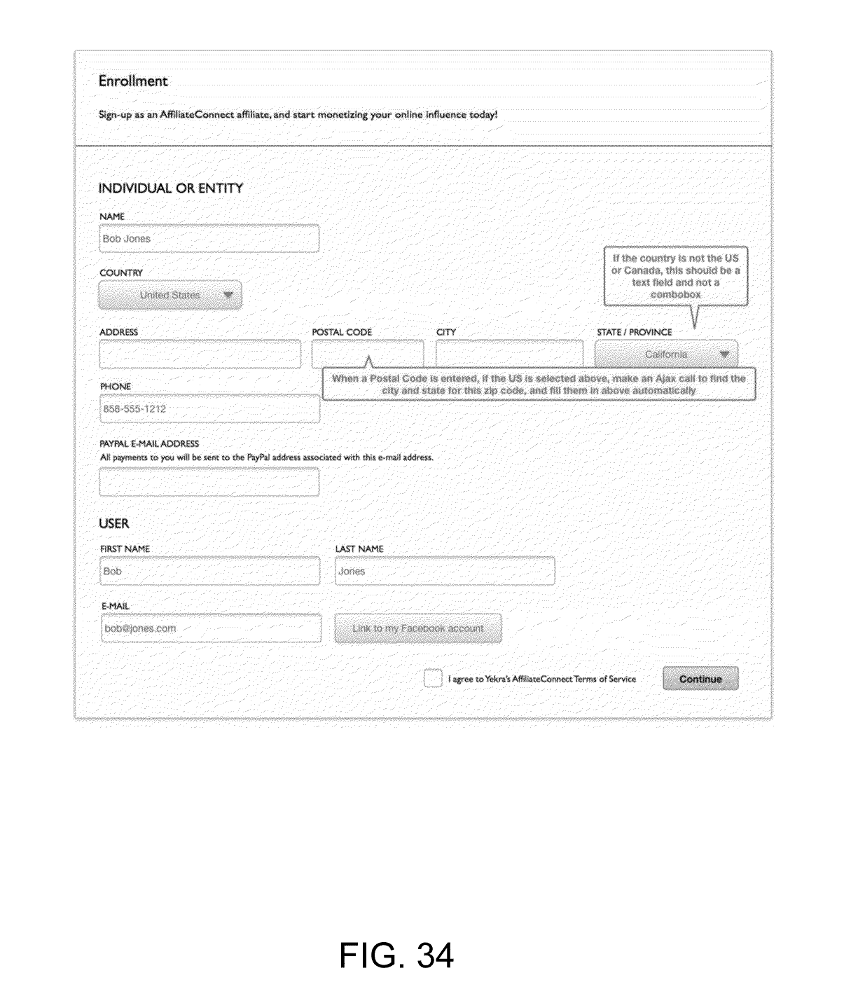

FIG. 34 is an illustration of one possible interface for allowing new resellers to register as affiliates. In one embodiment, an affiliate may register with a system in accordance with the present invention. An affiliate may then become a member of an affiliate network and begin searching for available vendor's products to resell.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to track multiple variable commissions and resale negotiations, the apparatus comprising:
a receiving module that receives a plurality of sales terms upon which a vendor's product may be made available for resale;
a connection module that connects the vendor to one or more resellers based on the sales terms;
a negotiation module that negotiates between the vendor and the resellers, the negotiation module rejecting modified offers from resellers that have not met a performance threshold,
wherein at least a portion of the receiving module, the connection module, and the negotiation module comprise one or more of hardware and executable code, the executable code stored on one or more computer readable storage media.

2. The apparatus of claim 1, wherein the sales terms include one or more of a base sales rate and an availability window.

3. The apparatus of claim 1, further comprising a monitor module that monitors individual reseller performance and adds individual reseller performance metrics to a database.

4. The apparatus of claim 1, wherein the performance threshold of the reseller comprises one or more of the size of an email list, a number of followers, a number of website visits, total sales figures, and previous sales with the vendor.

5. The apparatus of claim 1, wherein the connection module is further configured to search, in response to a reseller, for vendors based on one or more of a content rating, an offered sales commission rate, and a content genre.

6. The apparatus of claim 1, wherein the connection module performs one or more of searching for a vendor in response to a reseller, importing a contact list in response to a vendor, and importing a contact list in response to a reseller.

7. The apparatus of claim 1, further comprising a deployment module that provides deployment tools, the deployment tools comprising one or more of a universal resource locator, a link, a widget, a blog, and a social network.

8. A method for tracking multiple variable commissions and resale negotiations, the method comprising:
receiving a plurality of sales terms upon which a vendor's product may be made available for resale;
connecting the vendor to one or more resellers based on the sales terms; and
negotiating between the vendor and the resellers, wherein modified offers from resellers that have not met a performance threshold are rejected.

9. The method of claim 8, wherein the sales terms include one or more of a base sales rate and an availability window.

10. The method of claim 8, further comprising accepting offers from multiple resellers, wherein one or more of the accepted offers have different sales terms that others of the accepted offers.

11. The method of claim 8 further comprising tracking sales for respective resellers, and adding tracked sales information into a database.

12. The method of claim 8, wherein the performance threshold comprises one or more of an email list size, a number of followers, a number of website visits, a total sales amount, and a sales amount with the vendor.

13. The method of claim 8, wherein the connecting comprises connecting resellers to vendors based on one or more of a content rating, a sales commission base rate, and a content genre.

14. The method of claim 8, wherein the connecting comprises receiving a contact list of resellers from a vendor, and indicating the sales terms to the resellers in the contact list.

15. The method of claim 8, further comprising deploying one or more vendor's products using one or more of a universal resource locator, a link, a widget, a blog, and a social network.

16. A computer program product for tracking multiple variable commissions and resale negotiations, the computer program product comprising a computer readable storage medium having program code embodied therein, the program code readable/executable by a processor, the program code comprising:
a receiving module that receives a plurality of sales terms upon which a vendor's product may be made available for resale;
a connection module that connects the vendor to one or more resellers based on the sales terms;
a negotiation module that negotiates between the vendor and the resellers, the negotiation module rejecting modified offers from resellers that have not met a performance threshold,

17. The computer program product of claim 16, the program code further comprising a monitor module that monitors individual reseller performance and adds individual reseller performance metrics to a database.

18. The computer program product of claim 16, wherein the negotiation module negotiates between a vendor and a reseller based on properties of the reseller, wherein the, wherein the properties of the reseller comprise one or more of the size of an email list, a number of followers, and a number of website visits, total sales figures, and previous sales with the vendor.

19. The computer program product of claim 16, the program code further comprising a user interface module that receives information from one or a vendor and a reseller, and displays other information to one of a vendor and a reseller.

20. The computer program product of claim 17, wherein the connection module is further configured to connect resellers to vendors based on one or more of a content rating, a base commission rate, and a content genre.
